(19) United States
(12) Patent Application Publication
(10) Pub. No.: US 2025/0110022 A1
(43) Pub. Date: Apr. 3, 2025

(54) APPARATUS AND METHOD FOR MULTI-SENSOR HOME MONITORING AND MAINTENANCE

(71) Applicant: Dwellwell Analytics, Inc., Bethesda, MD (US)

(72) Inventors: Daniel Simpkins, Bethesda, MD (US); Charles Gritton, Sterling, VA (US); Thad Scheer, McLean, VA (US); John Christopher Kauffman, Reston, VA (US)

(21) Appl. No.: 18/834,294

(22) PCT Filed: Jan. 30, 2023
(86) PCT No.: PCT/US2023/011868

§ 371 Date: Jul. 30, 2024

Related U.S. Application Data
(60) Provisional application No. 63/305,184, filed on Jan. 31, 2022.

(51) Int. Cl. G01M 99/00; G06F 3/16

(52) U.S. Cl. CPC G01M 99/005; G06F 3/162

(57) ABSTRACT

Example embodiments include an apparatus and a method for monitoring a dwelling or set of dwellings using at least one sensor node. In some embodiments, a sensor node collects both audio data and non-audio data and detects at least one event or condition based at least in part on the audio data and the non-audio data. In other embodiments, audio data or non-audio data is used on its own or in other combinations. Processing may be performed to detect the presence of events, or changes in the frequency or duration of events, that may indicate a need for corrective action or preventative maintenance. Monitoring may apply to systems such as HVAC, electrical, structural, and plumbing, among others. Maintenance recommendations and monitoring parameters may by communicated to a user (e.g. to a resident, a property manager, a customer, or a designated service or maintenance person) over a networked service.

### CROSS-REFERENCE TO RELATED APPLICATIONS

The present application is a non-provisional filing of, and claims benefit under 35 U.S.C. § 119 (e) from, U.S. Provisional Patent Application Ser. No. 63/305,184, entitled “Apparatus and Method for Multi-Sensor Home Monitoring and Maintenance,” filed Jan. 31, 2022, which is hereby incorporated by reference in its entirety.

### SUMMARY

The present disclosure relates to systems and methods for monitoring a dwelling using at least one sensor node. Such monitoring may be performed to identify problems and/or to recommend preventative maintenance in one or more home systems such as HVAC, electrical, structural, and plumbing. In some embodiments, a sensor node collects both audio data and non-audio data, and at least one event or condition based at least in part on the audio data and the non-audio data. In other embodiments, audio data or non-audio data is used on its own or in other combinations. Processing may be performed to detect the presence of events, or changes in the frequency or duration of events, that may indicate a need for corrective action or preventative maintenance. Monitoring may apply to systems such as HVAC, electrical, structural, and plumbing, among others. Maintenance recommendations and monitoring parameters may by communicated to a user over a networked service.

Example embodiments include a remote, multi-sensor, multi-node home and building maintenance system. Embodiments include a software-extensible monitoring and inference system that does not require directly attached sensors on all the appliances and home systems of interest. In some embodiments, contact sensors (such as water contact sensors that sound an audible alarm) may be used in combination with the systems described herein.

### BRIEF DESCRIPTION OF THE DRAWINGS

FIGS. 1A-1F illustrate different views of a sensor node used in some embodiments.

FIG. 2 is a graph illustrating classifier confidence as a function of time in a test of a simulated natural gas leak.

FIG. 3 is a graph schematically illustrating test results of an accelerometer in a sensor node in response to a tilt event.

FIG. 4 illustrates a graphic element that may be used to display data and inferences collected using systems according to some embodiments.

FIG. 5 schematically illustrates examples of features implemented in a sensor node in some embodiments.

FIG. 6 schematically illustrates examples of features implemented in an example hub device in some embodiments.

FIG. 7 is a functional block diagram of a data processing pipeline according to some embodiments.

FIG. 8 is a functional block diagram of a cloud service architecture used in some embodiments.

FIG. 9 illustrates the functional architecture of an example embodiment of a sensor node in some embodiments.

FIG. 10 illustrates the functional architecture of an example embodiment of a hub node in some embodiments.

FIG. 11 is a functional block diagram of an example classifier pipeline according to some embodiments.

FIG. 12 is another functional block diagram of an example classifier pipeline according to some embodiments.

FIG. 13 is a schematic block diagram illustrating features of a cloud service used in some embodiments.

FIGS. 14A-14C illustrate operation of an AI classifier on acoustic data as used in some embodiments.

FIG. 15 schematically illustrates a system architecture used in some embodiments.

### DETAILED DESCRIPTION

Property maintenance is a big problem and largely reactive today. Proactive maintenance is less expensive and less disruptive than reactive maintenance. Example embodiments operate to make proactive maintenance possible by, for example, providing an advance alert of maintenance items that may benefit from attention based on processing the sensor data and historical trends in the system. Example systems make use of remote sensing, rather than sensing directly attached to a particular appliance or home component. This allows a sensing to be done on a whole section or space in a residence allowing for holistic scanning of the home across various types of problems and affected appliances. Example systems and methods may be used in any type of residential structure (e.g. homes, apartments, condos, townhomes). Some embodiments may also be useful in commercial buildings.

Using machine learning applied to sensor data, example embodiments operate to identify HVAC, plumbing, appliance, environmental, mold and other problems. Example embodiments may provide a remote preventative maintenance platform for single-family homes and apartment buildings that provides alerts of actual or potential problems. Example embodiments may further be used to monitor energy and water use.

Example embodiments operate with the use of remote, virtual monitoring to detect hidden issues remotely throughout a property. Example embodiments use predictive intelligence to identify potential breakdowns at inopportune times and allow for targeted, proactive maintenance that may extend the life of major systems and reduce the overall cost of units. Some embodiments provide monitoring and reporting on every major home system. Monitoring may be performed remotely to minimize disruption to the property or tenants. Example embodiments combine one or more sensor nodes, each sensor node including a plurality of different sensor types, to collect data. An artificial intelligence system (e.g. a neural network) may be used to process the collected data to provide preventative & predictive capabilities.

### Example Architecture.

In some embodiments, one or more sensor nodes are disposed in a dwelling. The sensor nodes may be used to detect features relating to one or more of the following features: plumbing and water conditions, electrical system conditions, heating and cooling conditions, temperature and humidity conditions, indoor air quality conditions, CO and other gas conditions, noise and sound conditions, light levels and colors, vibration and tilt, and/or appliance performance. Through the detection of such conditions, potential issues such as one or more of the following may be identified: worn or defective air conditioning compressor, dirty air filter, pests such as mice, frozen pipes, leaking or faulty toilets, mold growth, leaking faucets, poor insulation, and/or a leaking roof.

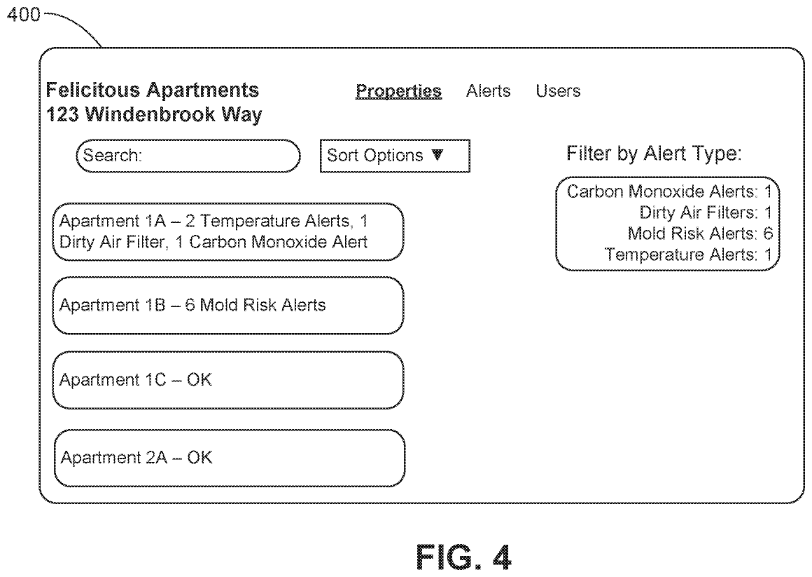

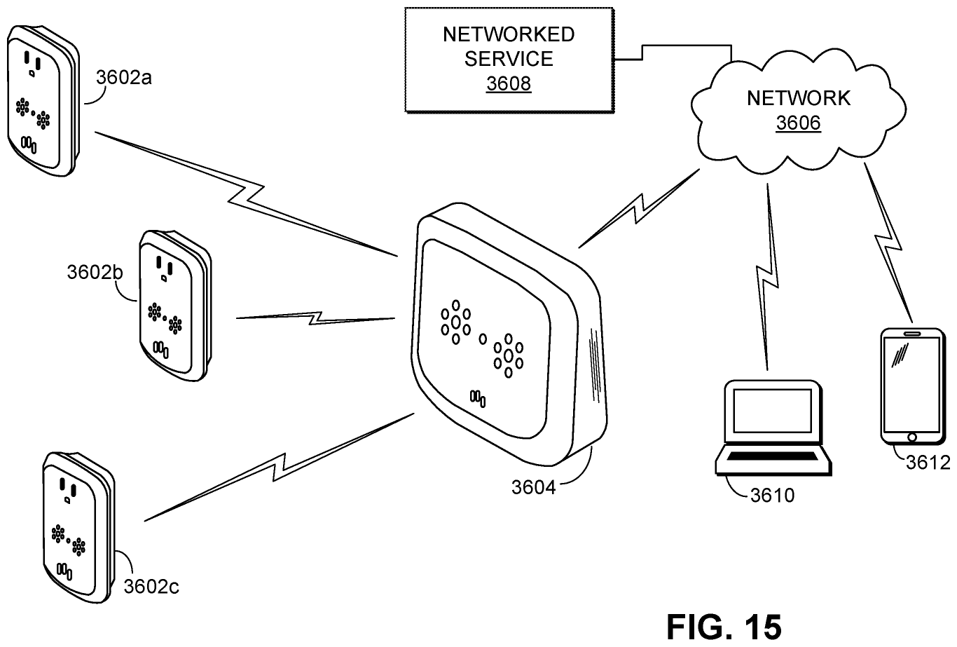

In an example system architecture, a plurality of sensor nodes are disposed in a dwelling, these sensors communicate with a hub node, and the hub node communicates with one or more networked services. The architecture is discussed in greater detail with respect to FIG. 15, below. The architecture allows for installation in a wide range or properties including Multi-Dwelling Units (MDUs or apartment buildings). An example of an interface 400 for monitoring conditions and alerts in different apartments is illustrated in FIG. 4. Such an interface may be accessible through, for example, a Web interface or through an application for a computer or mobile device, such as a tablet. The interface may allow for alerts to be searched, filtered, and sorted according to user options. For example, alerts may be filtered by alert type or sorted by alert severity

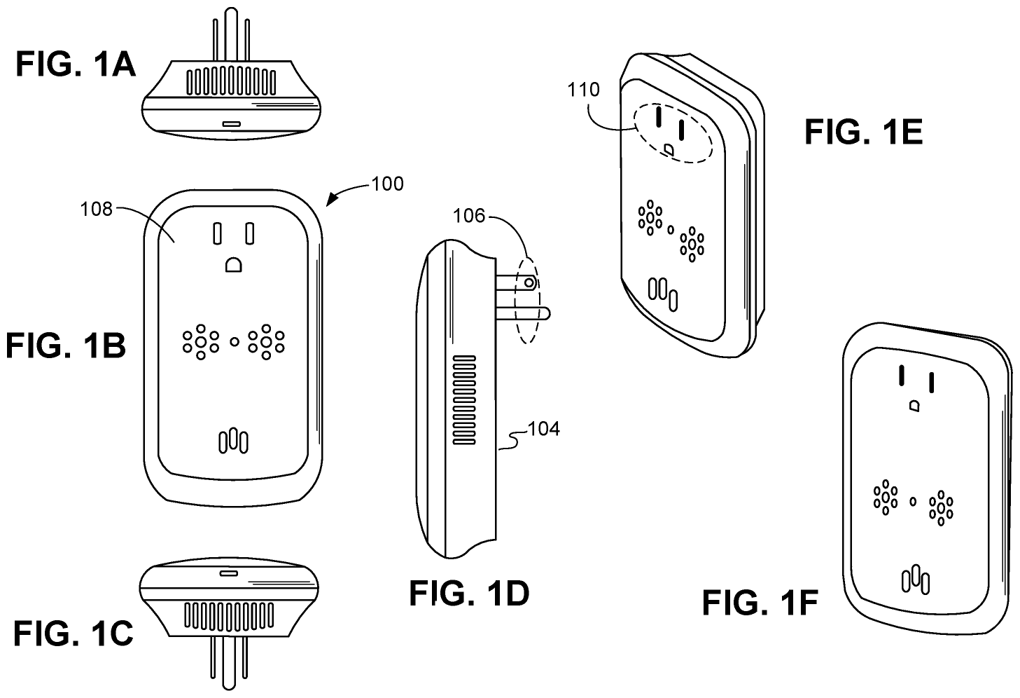

Components of an example system include a sensor node (which may be referred to as a “dNode”), such as sensor node 100 (FIGS. 1A-1F), with a plurality of different sensor modalities. The senor modalities may allow for collection of data regarding HVAC systems, appliance activity, plumbing conditions, structural monitoring, and pest detection. A hub device (which may be referred to as a “dHub”), such as device 3604 (FIG. 15) may be configured to process data from one or more sensor nodes in a dwelling. The hub device may be configured to perform operations such as sensor orchestration, event detection, threat analysis, data collection, and AI processing. The hub device may further provide a connection to cloud services, for example through a WiFi, Ethernet, or other network connection, which may be made through a household router or mesh network. In some embodiments, roughly one sensor node is installed for every 300 square feet of home area. In some embodiments, particularly in structures with multiple dwelling units, the hub may be a virtual component in a physical server that covers multiple residences at once. In example embodiments, no professional installation of the hub or sensor nodes is required.

Example systems described herein monitor the effects on the ambient environment of various conditions in the home and then infer from the set and relative timing of those ambient effects what the state of the home is. Examples of systems that may be monitored include HVAC, Plumbing & Water, Electrical and Indoor Environment monitoring. Example systems include software to collect and process the sensor data. Some embodiments further include a web application to implement a User Interface or User Experience for the user. This web app may also be implemented as a mobile app.

In some embodiments, an example system uses its sensor data to monitor the home HVAC system to determine its operational status and its efficiency. Some embodiments may further detect air filter cleanliness.

In some embodiments, an example system uses its sensor data to monitor the home plumbing and water system. Such embodiments may operate to detect water leaks and to track plumbing fixture status and usage.

Example embodiments are not limited to the monitoring of HVAC systems and plumbing fixtures. Various embodiments may use their sensor data to monitor various other domestic fixtures. As used herein, the term domestic fixtures includes both attached and non-attached appliances and equipment as well as a home structures such as walls, doors or windows. Example embodiments may operate to determine the operational status and efficiency of various such domestic fixtures, such as the presence of such fixtures in various operating states or failure states.

In some embodiments, an example system uses its sensor data to monitor the home electrical system. Such embodiments may operate to detect voltage levels, outlet wiring issues, and potential electrical fire hazards.

In some embodiments, an example system uses its sensor data to monitor the indoor environment. Such embodiments may operate to comfort levels, air quality, noise levels, carbon monoxide, and potential mold conditions.

In example embodiments, the system operates using AI software that is trained at least in part using real-world data collected after installation. In addition, software of the sensor node and hub device may be updated after installation. In some embodiments, a web-based application provides a management dashboard and alerting system.

In some embodiments, the system performs HVAC system operation and performance monitoring. For example, the system may measure HVAC system performance to identify changes in efficiency, detect problems, and prevent unexpected outages. In some embodiments, the system operates to determine when the HVAC air filter is dirty.

In some embodiments, the system performs plumbing, water usage, and leak monitoring. For example, the system may monitor operation and water usage, and it may detect bathroom toilet leaks. The system may identify unusual changes in water usage patterns,

In some embodiments, the system may monitor environmental conditions to increase tenant comfort, health and safety. In some embodiments, the system monitors temperature, humidity, indoor air quality (IAQ), noise and light levels. In some embodiments, the system monitors carbon monoxide (CO) and/or identifies mold risk.

In some embodiments, the system may perform electrical system status and risk monitoring. For example, the system may operate to identify faults in electrical outlet wiring. The system may measure the status of the electrical service to identify abnormal fluctuations such as sags, swells and surges.

Some embodiments provide portfolio visibility and increase workflow efficiency by providing a management dashboard for a collection of properties. The management dashboard may show operational and performance data, and active alerts and warnings.

Some embodiments allow for continuous improvement over time. For example, the system may learn and adapt to its environment, improving home monitoring ability, providing more valuable insights, and helping avoid catastrophic issues. Regular software updates may be used to add features and expand preventative maintenance capabilities.

In some embodiments, environmental sensing includes measurement one or more of the following:
Temperature
Humidity
Comfort
Mold Risk
Indoor Air Quality (IAQ)
CO & CO2
Noise
Light
Methane (e.g. through detection of mercaptan additive levels)
Vibration

Such environmental sensing may include charting of results, making a determination of when results exceed one or more thresholds, and providing notifications based on the results.

In some embodiments, electrical sensing includes sensing of voltage (charting, thresholds/events, notifications) and sensing outlet wiring and providing appropriate status information and notifications.

In some embodiments, sensing relates to maintenance services and may include sensing of information regarding one or more of the following:
HVAC Operation
HVAC Efficiency
HVAC Issue Notification (based on changes in efficiency)
HVAC Filter Change Notification
Toilet Operation
Toilet Issue Notification
Bathroom Fixture Operation
Drip and Gushing Water Notification
Water Leak Alarm Notification
Appliance Inventory with Recall Notifications

In some embodiments, features of the system include one or more of the following:

| Product Capability | Operational Benefit | Tenant Benefit |
|---|---|---|
| Single-View Dashboard, | Save Time, “Triage” | Tenant concerns and needs are |
| Comprehensive Alerts | Repairs | addressed in a logical, priority |
| | | order. |
| “Plug & Play” Set-Up | Simple Installation, No | No disruption to the tenant's home |
| | Disruption | or comfort. Installation can be |
| | | scheduled at tenant's convenience. |
| Built to Self-Improve | More Accurate Diagnoses | Over time, predictive maintenance |
| | | will reduce disruption and the need |
| | | for emergency repairs. |
| Non-Invasive Monitoring | Ensure Lease Compliance | Doesn't inconvenience tenant's |
| | | time or schedule - conditions are |
| | | tracked remotely instead of via a |
| | | “surprise visit.” |

In some embodiments, features of the system relating to HVAC monitoring include one or more of the following:

| Insights | Sensing and Algorithms |
|---|---|
| Efficiency and uniformity | Detects and charts ON/OFF state and statistics of HVAC |
| of heating/cooling | system based on acoustic, temperature and humidity sensing |
| throughout the residence | Charts efficiency statistics based on temperature response in |
| | residence during HVAC ‘on’ time |
| | Charts thermal retention statistics based on temperature |
| | response in residence during HVAC ‘idle’ time |
| Servicing needed due to | Alerts on need for air filter maintenance based on HVAC |
| normal maintenance, | run time and time since last change |
| reduced performance or | Alert based on efficiency threshold exceeded |
| not operating correctly | Alert based on temperature threshold exceeded |
| Expected comfort level | Charts comfort rating index based on temperature and |
| of resident | humidity |
| | Alert based on temperature and humidity thresholds exceeded |

In some embodiments, features of the system relating to plumbing/water monitoring include one or more of the following:

| Insights | Sensing and Algorithms |
|---|---|
| When and where is water | Detects and charts water usage from ON/OFF state and |
| being used | statistics of plumbing fixtures; based on acoustic, |
| | temperature, humidity, VOC and light sensing |
| Servicing needed due to | Detects and alerts when fixtures left on indefinitely |
| unusual water/plumbing usage | Detects and alerts on toilet malfunctions based on |
| or fixtures not operating | abnormal state behavior |
| correctly | Detects and alerts on dripping fixtures based on acoustic |
| | sensing |
| Leaks or flooding | Detects and alerts on gushing water based on acoustic |
| (water where | sensing |
| it should not be) | Detects and alerts on acoustic alarm from contact water |
| | sensor |

In some embodiments, features of the system relating to electrical monitoring include one or more of the following:

| Insights | Sensing and Algorithms |
|---|---|
| Overall status and | Detects and charts RMS voltage and statistics for each circuit |
| uniformity of AC electricity | where sensor nodes are installed; based on voltage sensing |
| throughout the residence | hardware |
| Servicing needed and | Alerts on and charts voltage thresholds exceeded for |
| potential fire risk due to | overvoltage, undervoltage and service interruptions |
| improper power distribution, | Detects and alerts on wiring faults in outlets where sensor nodes |
| overloaded circuits or faulty | are installed; based on software algorithm using ratios of |
| wiring | Line/Neutral/Ground values |
| Potential damage risk to | Detects and alerts on electrical surges in outlets where sensor |
| appliances and equipment | nodes are installed; based on surge sensing hardware |

In some embodiments, features of the system relating to environmental and structural monitoring include one or more of the following:

| Insights | Sensing and Algorithms |
|---|---|
| Overall status and | Senses and charts temperature, humidity, sound level, indoor air |
| uniformity of environmental | quality (VOC), carbon monoxide, air pressure and light level for |
| conditions throughout the | each room where sensor nodes are installed |
| residence | |
| Risk to health of residents | Alerts on mold risk index threshold exceeded; based on |
| and/or property | temperature, humidity, light and VOC sensing |
| | Alerts on any of temperature, humidity, sound level, air quality, |
| | CO, air pressure thresholds exceeded |
| | Detects and Alerts on movement of residence due to earthquake; |
| | based on sensing of physical acceleration |
| Occupancy of residence | Air quality and sound level are good indicators of the presence |
| | of humans in a residence |

As an example, sensor data collected in some embodiments includes one or more of the following types of sensor data. Environmental sensor data may be collected such as temperature, humidity, external weather, light and color, indoor air quality, carbon monoxide levels, VOC levels associated with natural gas, VOC levels associated with termite activity, and VOC levels associated with mold growth. Vibration sensor data such as acoustic data, ultrasound data, and low frequency vibrations may be detected. Electrical sensor data such as voltage levels and voltage surges may be detected.

Features that may be detected or determined based on the collected sensor data include one or more of the following types of features. Environmental features may be detected such as mold growth, or a comfort rating may be generated. Water and plumbing features may be detected such as toilet flush/fill operations, water leaks, bathroom sink operation, shower operation, tub operation, sump pump operation, gushing water, dripping water, running toilet, ghost flushing, water usage, water heater operation, kitchen sink operation, and clogged drains. Electrical features such as wiring faults may be detected. HVAC features may be detected such as HVAC operation, HVAC efficiency, temperature retention, air filter cleanliness, condensate pump operation, and HVAC equipment malfunctions. Appliance features may be detected such as washer/dryer operation, dishwasher operation, or other kitchen appliance operation. Pest activity, such as the presence of mice, rats, bats, or other animals may be detected. Security features such as occupancy status of the dwelling may be detected. Structural events such as breaking glass and hail may be detected. Alarm activity may be detected, such as fire, carbon monoxide, or security alarms, or low-battery chirp sounds for such alarms.

In some embodiments, a software platform provides one or more of the following features. A user experience (UX) platform may provide a web-based interface, an installation user interface, a user management interface, email and text notifications, historical charting, operational statistics, threshold-based alerting, appliance inventory, appliance failure risk and recall alerts, trend-based alerting, mobile app user interface, API integrations, maintenance logistics, and contractor links. A cloud platform may provide production cloud deployment, statistical analysis of operational faults and anomalies over time, and appliance database integration. A hardware platform may provide sensor node and hub node equipment with appropriate regulatory certifications. Cellular service connectivity may also be provided.

Example embodiments make use of a remote-sensing approach. Compared to products with system-specific sensors, example embodiments can monitor more systems simultaneously. Some embodiments do not require a direct connection to each monitored system.

Compared to products with general-purpose sensors, example embodiments use a more sophisticated multi-modal approach that includes one or more (or all) of electrical, light, humidity, temperature, gas, motion, and acoustic sensors. Some embodiments may collect additional information by, for example, monitoring the RF environment, collecting data from a network (e.g. through a cloud service) or through data retrieved by and exchanged among a plurality of sensor nodes. In some embodiments, analysis is performed on site versus the cloud, providing for efficient bandwidth usage but also increased security and privacy. Example architectures support an AI-based approach which allows for the gathering of large amounts of information providing more specific diagnostic notifications. In some embodiments, collected data is used to improve the accuracy of sensor data and of determinations made from data analysis, e.g. through training of artificial intelligence (AI) classifiers.

### CO Detection.

In some embodiments, sensor nodes include a carbon monoxide (CO) sensor that provides the sensor node to CO levels. In embodiments where a plurality of sensor nodes are installed in a dwelling, the sensor nodes may be used to localize the source and center of an increase in CO. In some embodiments, CO sensor readings are analyzed to determine potential periodicity in CO release (e.g. detection of periodic CO rise every Tuesday).

In some embodiments, CO sensors (and other gas sensors as described herein) collect information regarding potential problems even before gas concentrations escalate to a dangerous level. Conventional CO detectors have fixed (integrated) threshold levels that lead to an alarm being sounded to alert people to a critical health issue that already exists. Example embodiments described herein analyze the CO to predict issues with appliances and systems generating or leaking CO before they become a critical health issue. Such preventative and diagnostic techniques may be used on their own or in combination with more conventional threshold-based alarm features.

In example embodiments, an alert of a high CO level is provided (e.g. to a resident, owner, or property manager) of a CO issue. Such an alert may be provided before the issue becomes dangerous or life-threatening. For example, an alert may be be sent (e.g. via an app, SMS, or other message type) in response to initial detection of elevated CO levels (e.g. levels above a threshold), with content such as the following:
XYZ Properties>Unit 12>Room A
CO Alert
Today, 11:35 AM—Now
Unusual CO rise—potential leak or fire.

In response to a determination that, after elevated CO levels were detected by a first sensor node (in Room A), elevated CO levels were subsequently detected by a second and third sensor node (in Rooms B and C), an alert that may be sent such as the following:
XYZ Properties>Unit 12>Rooms A, B, C
Spreading CO Alert
Today, 11:40 AM—Now
Unusual CO rise—potential leak or fire.

Once CO levels return to normal (e.g. below a threshold), an alert may be sent as follows:
XYZ Properties>Unit 12>Rooms A, B, C
CO Back to Normal
Today, 11:45 AM—Now
CO levels back to normal.

### Gas Leak Detection.

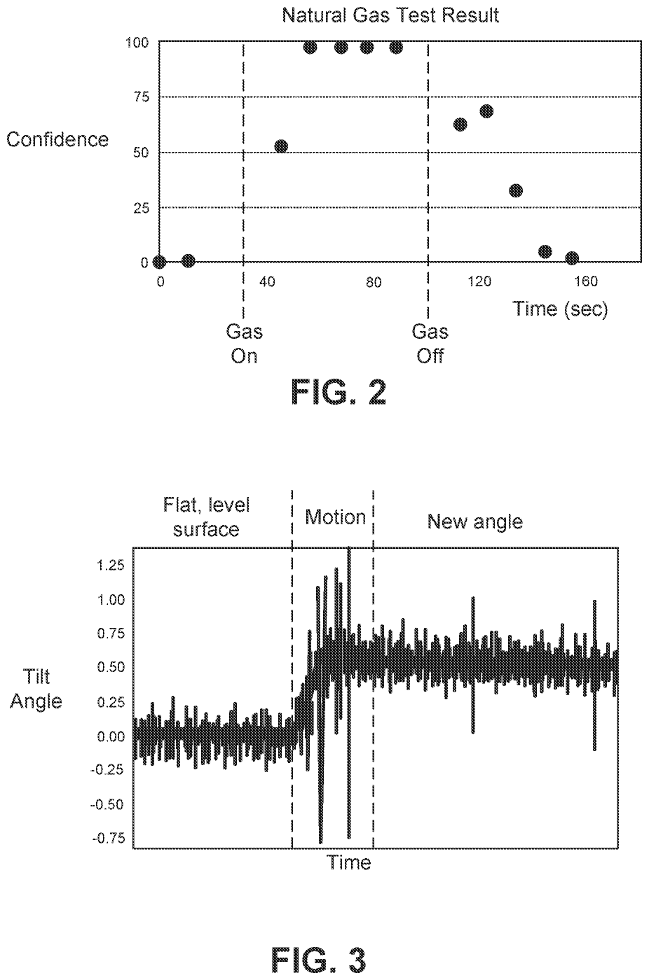

In some embodiments, the sensor node further includes a gas sensor to detect natural gas or other volatile organic compounds. FIG. 2 illustrates testing of a sensor node equipped with a gas sensor. The graph shows the confidence of the detector quickly jumping up once the gas is on and then return once the gas is off.

In embodiments where a plurality of sensor nodes are installed in a dwelling, the sensor nodes may be used to localize the source and center of an increase in gas concentration. An alert may be provided before the issue becomes dangerous or life-threatening. Such an alert may thus be provided before gas levels reach a concentration that would trigger an alert by a conventional sensor.

As an example, an alert that may be sent (e.g. via an app, SMS, or other message type) in response to initial detection of elevated gas levels (e.g. levels above a threshold) conveying information such as the following:
XYZ Properties>Unit 12>Kitchen
Natural Gas Alert
Today, 11:35 AM—Now
Natural Gas Detected—potential leak.

In response to a determination that, after elevated gas levels were detected by a first sensor node (in the kitchen), elevated gas levels were subsequently detected by a second sensor node (in the den), an alert that may be sent as follows:
XYZ Properties>Unit 12>Kitchen and Den
Spreading Natural Gas Alert
Today, 11:40 AM—Now
Natural Gas Detected—potential leak.

Once natural gas levels return to normal (e.g. below a threshold), an alert may be sent as follows
XYZ Properties>Unit 12>Kitchen and Den
Natural Gas Back to Normal
Today, 11:45 AM—Now
Natural Gas Levels Back to Normal.

### Structural Issue Detection.

In some embodiments, each sensor node includes at least one accelerometer to detect structural stress events such as earthquakes or construction vibration. Such a sensor node may be tested with the use of a solenoid actuator to move (e.g. shake or vibrate) the sensor node along one or more axes. The solenoid actuator may move the sensor according to simulated seismic waves or recordings of actual seismic waves. In some embodiments, the degree of structural damage risk caused by detected seismic waves is estimated using a table such as the table below, which is based on USGS data.

| Instrumental | Acceleration | Velocity | Perceived | Potential |
|---|---|---|---|---|
| Intensity | (g) | (cm/s) | Shaking | Damage |
| I | <0.0017 | <0.1 | Not felt | None |
| II-III | 0.0017-0.014 | 0.1-1.1 | Weak | None |
| IV | 0.014-0.039 | 1.1-3.4 | Light | None |
| V | 0.039-0.092 | 3.4-8.1 | Moderate | Very Light |
| VI | 0.092-0.18 | 8.1-16 | Strong | Light |
| VII | 0.18-0.34 | 16-31 | Very Strong | Moderate |
| VIII | 0.34-0.65 | 31-60 | Severe | Moderate to Heavy |
| IX | 0.65-1.24 | 60-116 | Violent | Heavy |
| X+ | >1.24 | >116 | Extreme | Very Heavy |

An alert may be sent to a user. In response to detection of a seismic event above a first threshold level, a message such as the following may be sent to a user:
XYZ Properties>Building A
Structural Stress Event Detected
Today, 2:35 PM—Now
Strong Vibrations Detected—potential damage.

In some embodiments, an alert may be sent in response to detection of multiple (e.g. more than a predetermined number of) seismic events above a second threshold level within a particular time frame. The second threshold level may be lower than the first threshold level. For example, an alert may be sent as follows:
XYZ Properties>Building A
Multiple Structural Stress Events
Today, 11:40 AM—Now
5 Instances of Strong Vibrations in Last 2 Months.

Other criteria may also be used in determining the existence of a seismic event, e.g. to prevent the handling or dropping of a sensor node, or movement of occupants, from being reported as a structural stress event. In some embodiments, accelerometer readings from a plurality of sensor nodes in a structure are compared with one another to confirm whether any acceleration (e.g. shaking) was a building-wide event.

In some embodiments, the accelerometers in one or more sensor nodes may be used in detecting a structural tilt event, which may occur for example when the foundation or ground shifts below a structure. In some embodiments, tilt changes of at least 0.5° are detected. FIG. 3 schematically illustrates data collected by a sensor node during a tilt event detected by an accelerometer of the sensor node.

In some embodiments, to ensure that detected tilt event is building wide, readings are compared across all the installed sensor nodes. The detection of a tilt event may be reported to a user with a message such as the following:
XYZ Properties>Building A
Structural Tilt Event Detected
Today, 2:35 PM—Now
Building Tilt Change Detected-Potential Damage.

The detection of repeated tilt events may be reported to a user with a message such as the following:
XYZ Properties>Building A
Continuing Structural Tilt Events
Today, 11:40 AM—Now
3 Building Tilt Changes in Last 2 Months.

The use of accelerometer-equipped sensor nodes as described herein allows for continual measuring for potential structural tilt. In some embodiments, a comparison is made of accelerometer readings from distributed sensors to distinguish structure-wide tilt change from someone bumping into or handling a single sensor node.

### Electrical Fire Hazard Detection.

Example embodiments include sensors configured to detect the risk or presence of home electrical fires. In some embodiments, a sensor node incudes some or all of the following sensors: a VOC sensor, an ambient light sensor (ALS) capable of detecting color shifts, a microphone or other audio sensor, electrical circuitry sensors to detect anomalies in electrical power supply circuits, a humidity sensor, a temperature sensor, and/or an accelerometer.

An alert that may be sent (e.g. via an app, SMS, or other message type) in response to initial detection of a fire as in the following example:
XYZ Properties>Unit 12>Room A
Fire Alert
Today, 11:35 AM—Now
Signs of fire detected.

An alert that may be sent in response to a determination that, after a fire was detected by a first sensor node (in Room A of Unit 12), fire was subsequently detected by additional sensor nodes (in Units 10, 11) may be sent according to the following example:
XYZ Properties>Unit 10, 11, and 12
Spreading Fire Alert
Today, 11:40 AM—Now
Potential fire spreading out from Unit 12.

Once the fire is extinguished, an alert may be sent according to the following example:
XYZ Properties>Unit 12>Rooms A, B, and C
Fire No Longer Detected
Today, 11:45 AM—Now
No signs of fire detected.

### Mold Risk Detection.

In some embodiments, a sensor node is equipped with one or more (or all) of the following sensors to detect conditions that are favorable to mold growth: temperature sensor, humidity sensor, light sensor. In some embodiments, a sensor node is further equipped with a VOC sensor capable of detecting evidence of mold growing by sensing the resulting VOCs that are generated.

### Unauthorized Inhabitant Detection.

In some embodiments, sensor data collected from one or more sensors as described herein may be used to detect occupancy of a dwelling. For example, sensor detection of changes in lighting conditions, sound, and electrical transients may be used to detect the presence of an occupant. In some embodiments, a dwelling associated with the sensor node may be categorized (e.g. in a database) as vacant. In some such embodiments, in response to detection of occupancy in a dwelling that is categorized as vacant, an alert may be sent to indicate the presence of a possible trespasser or squatter.

### Excessive Noise Detection.

In some embodiments, sensor data collected from one or more sensors as described herein may be used to detect noise levels in a dwelling. In some embodiments, a sensor node includes the ability to measure the noise level continuously. In some embodiments, an AI classifier operates to determine whether noise levels are excessive and prone to result in noise complaint. In some embodiments, a determination of whether to provide an alert is further based at least in part on one or more other sensor readings (e.g. gas, accelerometer) to characterize whether an event is likely to lead to a complaint.

An alert may be sent in response to detection of excessive noise according to the following example:
XYZ Properties>Unit 12>Room A
Loud Noises Detected
Today, 11:35 AM—Now
Loud noises detected—possible violation.

An alert may be sent in response to a determination that noise levels have been restored to a normal level according to the following example:
XYZ Properties>Unit 12>Room A
Normal Noise Level Restored
Today, 11:40 AM—Now
Normal noise levels detected.

### Faulty Toilet Detection.

In some embodiments, sensor data collected from one or more sensors as described herein may be used to detect faulty operation of a toilet. A sensor node may be equipped with one or more sensors, including e.g. audio sensors such as a microphone, that collect data regarding toilet activity. The data may be provided to an AI classifier such as a trained neural network (e.g. a convolutional neural network) to determine whether the toilet activity is unusual (e.g. an unusual duration of refill times, or sounds of water flowing that are not preceded by an initial flush sound). In some embodiments, a neural network is used in conjunction with associated supporting processing such as auto-calibration, post-classifier Finite State Machines, and post-processing to optimize the data and alerts for the user interface. Early detection of deterioration in toilet performance may allow corrective action to be taken before significant damage occurs.

An alert may be sent in response to detection of unusual toilet activity according to the following example.
XYZ Properties>Unit12>Bathroom A
Possible Faulty Toilet
Today, 11:40 AM—Now
Toilet behaving unusually—potential fault.

An alert may be sent in response to a determination that the toilet has resumed normal behavior according to the following example:
XYZ Properties>Unit12>Bathroom A
Toilet Behaving Normally
Today, 11:40 AM—Now
Toilet behaving normally.

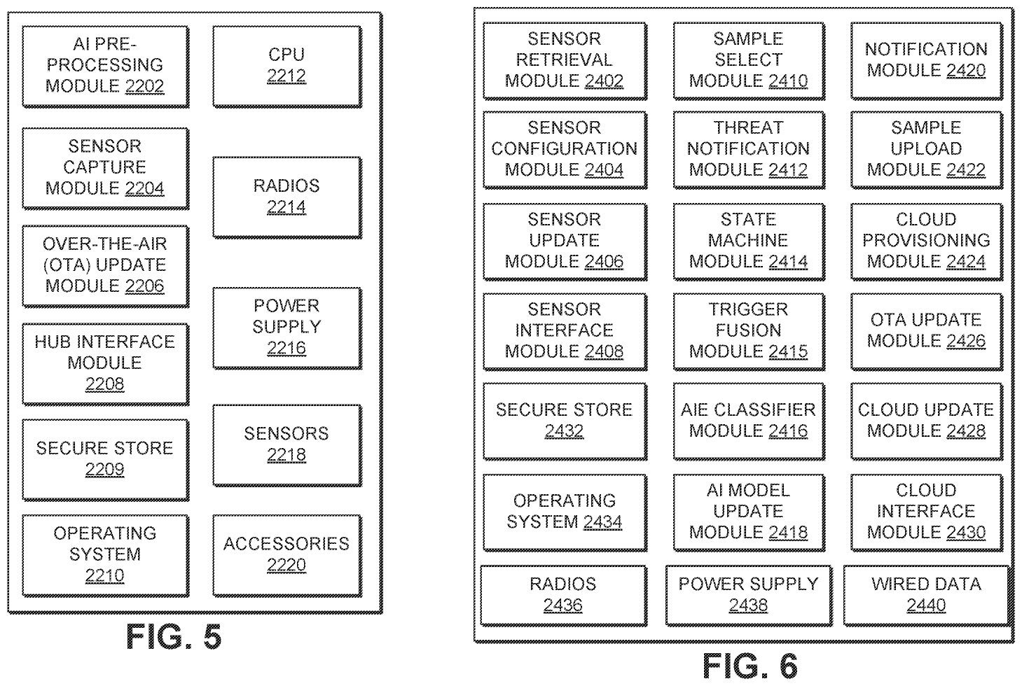

FIG. 5 schematically illustrates examples of features implemented in a sensor node in some embodiments. Software-implemented features in this example include an AI preprocessing module 2202 to prepare sensor data for use by an AI classifier, a sensor data capture module 2204 for managing collection of sensor data, an over the air (OTA) update module for receiving and implementing software updates, a hub interface module 2208 to manage communications with a hub node, a secure store 2209 to securely store collected sensor data, and an operating system 2210. Hardware features in this example include a CPU 2212, one or more radios 2214 for WiFi and/or Bluetooth communication, power supply hardware such as AC connections and rechargeable battery power, sensors 2218 such as a humidity sensor, a VOC sensor, a microphone, a light sensor, a temperature sensor, and an accelerometer, and accessories such as a nightlight, a status LED, and a speaker.

FIG. 6 schematically illustrates examples of features implemented in an example hub device in some embodiments. Such features may include a sensor node interface components such as a sensor data retrieval module 2402, a sensor configuration module 2404, a sensor update module 2406 for providing OTA updates to the sensor nodes, and a sensor interface module 2408 for managing communications with the sensor nodes. The hub device may include AI engine components such as a sample select module 2410, a threat notification module 2412, a state machine module 2414, a trigger fusion module 2415, an AI engine classifier module 2416, and an AI model update module 2418. The hub node may further include cloud interface components such as a notification module 2420, a sample upload module 2422, a cloud provisioning module 2424, an OTA update module 2426, a cloud update module 2428, and a cloud interface module 2430. The hub may further include hardware platform components such as a secure store 2432, an operating system 2434, radios 2436 (such as WiFi and/or cellular data), a power supply 2438, and wired data connections 2440, such as an Ethernet connection.

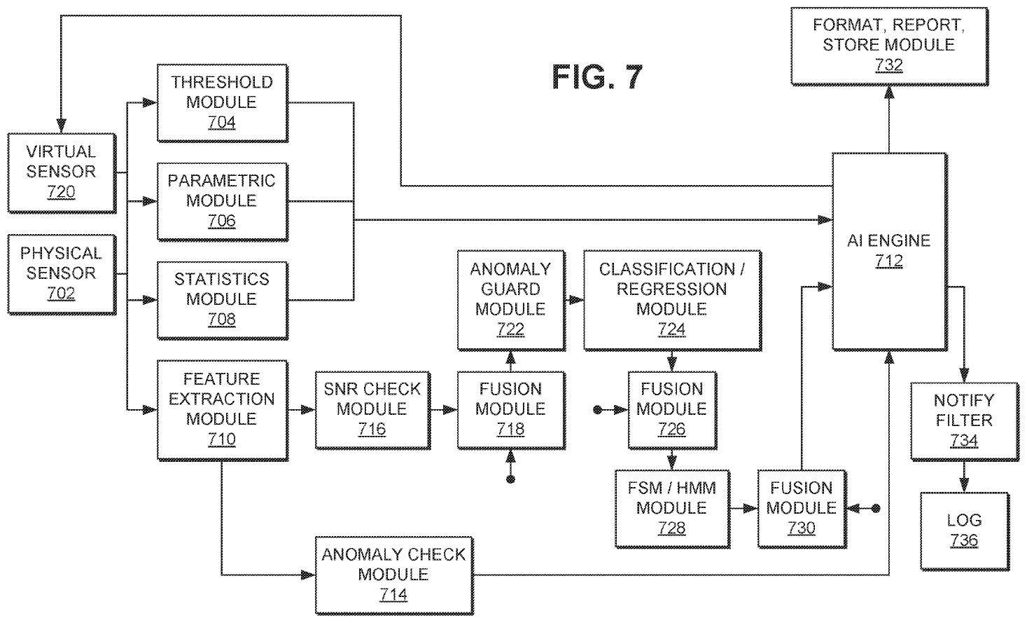

A functional flow diagram illustrating processing of sensor data according to some embodiments is provided in FIG. 7. In some embodiments, at least some of the operations illustrated in FIG. 7 may be implemented on a hub device. In some embodiments, at least some of the operations of FIG. 7 are performed on a sensor node. In some embodiments, at least some of the operations of FIG. 7 are performed by a cloud service. Different embodiments may divide the operations among different hardware components in different ways. Some embodiments exhibit one or more of the following features:
Direct dealing with dataset shift with explicit unsupervised and small data semi-supervised bootstrapping
Context across multiple sensors with varied levels of sensor fusion
Exploits domain knowledge in both defining events of interest and framing the desired questions
Multi-layer AI Engine allowing use of simplest model for each question

As illustrated in FIG. 7, one or more physical sensors 702 provide sensor data to one or more of a plurality of modules, such as a threshold module 704, a parametric module 706, a statistics module 708, and a feature extraction module 710. The output of the threshold module 704, parametric module 706, and statistics module 708 may be provided directly to an artificial intelligence engine 712. An output of the feature extraction module 710 may be further processed, for example, by an anomaly check module 714 before being provided to the AI engine 712. An SNR module 716 may also process the data. The data may further be provided to a fusion module 718, which performs sensor fusion to combine the output of physical sensor 702 with the outputs of other physical sensors and/or with one or more virtual sensors such as virtual sensor 720.

The output of sensor fusion module 718 may be provided to an anomaly guard module 722, which in turn provides its output to a classification regression module 724. The output of the classification regression module 724 may in turn be provided to a further fusion module 726.

The output of the fusion module 726 is provided to a finite state machine/hidden Markov model module 728. The output of the a finite state machine/hidden Markov model module 728 may in turn be provided to a further fusion model 730, whose output may be provided to the AI engine 712. An output of the AI engine 712 may be used in one or more of several ways. The output may be used as input to one or more virtual sensors 720. The output may be provided to a module 732 for formatting, storing, and reporting the output. A notification filter 734 may also process the output and log any resulting notifications using module 736. In some embodiments, the input or output of one or more of the modules of FIG. 7 is identified and selected for offline analysis to allow for assessment and/or improvement of the data processing algorithms and AI models used by the system.

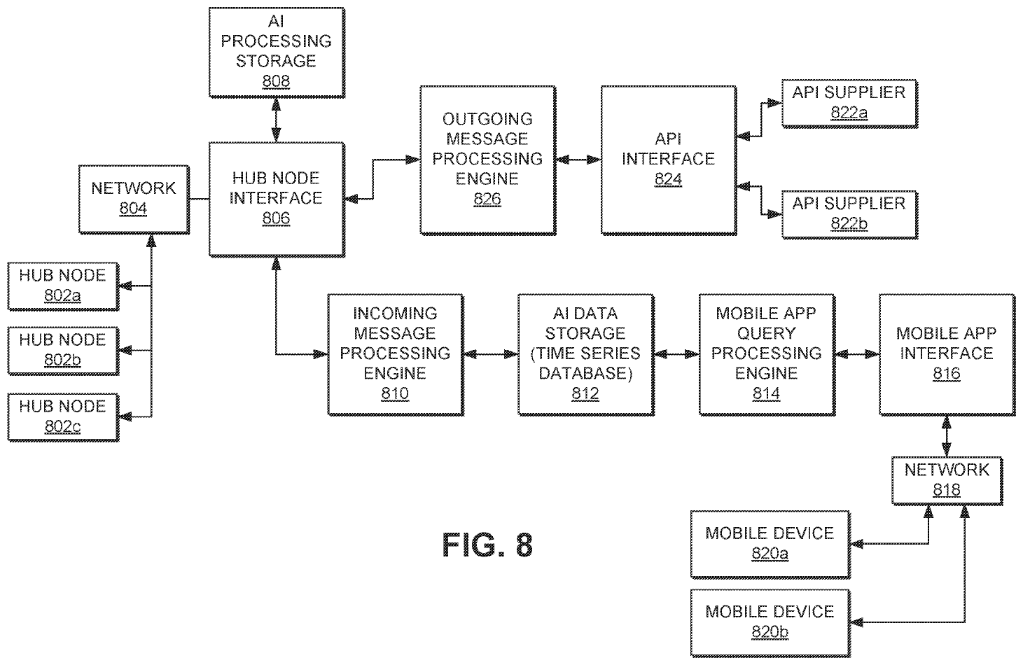

An example of a cloud service architecture used in some embodiments is provided in FIG. 8. A plurality of hub nodes, such as nodes 802a, 802b, 802c, are in communication with the cloud service over a network 804. The hub nodes may be installed in different dwellings. A hub node interface 806 is provided to manage communications with the hub nodes. Raw and/or processed sensor data from the hub nodes may be provided to storage 808 for offline AI processing. Messages received from the hub nodes may be processed by an incoming message processing engine 810. Time series data representing, for example, operational or fault conditions of domestic fixtures, may be stored by database 812. Information in the database may be made accessible to authorized users through, for example, a mobile application interface 816, which allows users of mobile devices (e.g. 820a, 820b) to monitor home status data over a network 818. The cloud service architecture may further collect information provided by outside sources, such as API suppliers 822a, 822b. Such information may be collected by an API interface 824 of the cloud service and may be processed by an outgoing message processing engine 826.

### Hardware Architecture.

As illustrated in FIGS. 1A-1F, a device 100 includes a housing 108 having a rear surface 104. A set of power plug prongs 106 extends from the rear surface of the housing. Although the illustrated prongs are those compatible with standard North American outlets, other configurations may alternatively be used.

Features of some embodiments of a sensor node may include one or more of the following.

Other Features

| | |
|---|---|
| Power | AC powered |
| | Battery backup |
| Connectivity | WiFi |
| ID | Sized to plug into normal AC outlet |
| | (may be configured differently for |
| | different local outlet standards) |
| | AC pass through socket |
| | Can be secured to wall for installation |
| | in rental properties |
| Indicators | LED for dNode status |
| | Nightlight |
| | Speaker for alerts |

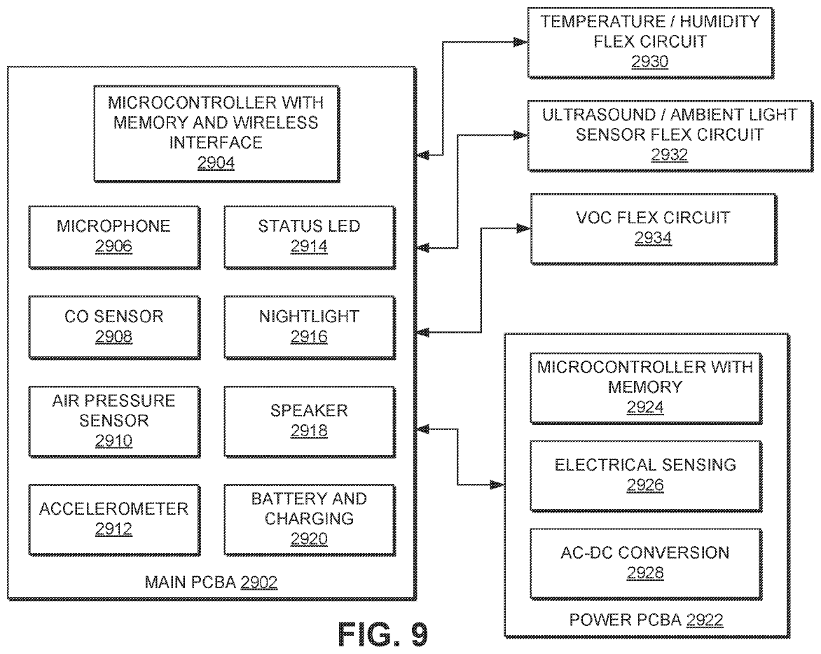

The functional architecture of an example embodiment of a sensor node is illustrated in FIG. 9. In the embodiment of FIG. 9, a main printed circuit board assembly (PCBA) 2902 includes a microcontroller unit 2904 with associated memory, sensors such as a microphone 2906, a CO sensor 2908, an air pressure sensor 2910, and an accelerometer 2912. The main PCBA may further include a status LED 2914, a nightlight 2916, a speaker 2918, and componentry 2920 for use and charging of a backup battery. A power PCBA 2922 in this example includes a microcontroller 2924 with associated memory, circuitry 2926 for voltage sensing, and circuitry 2928 for AC-DC conversion which may be used to power the sensor node. In addition, this embodiment includes a first flex circuit 2930 with temperature and humidity sensors, a second flex circuit 2932 with an ultrasound microphone and an ambient light sensor (ALS), and a third flex circuit 2934 with a gas (VOC) sensor. The arrangement of components on PCBs and flex circuits may be different in different embodiments. For example, the use of flex circuits is not critical to the functionality of the product. Similar functionality is implemented in some embodiments using component connections implemented other ways.

In some embodiments, a hub device may include one or more of the following features.

Features

| | |
|---|---|
| Power | AC powered |
| Connectivity | WiFi |
| | Ethernet |
| ID | Designed to stand on desk or mount to wall |
| | Can be secured to wall for installation in |
| | rental properties |
| Indicators | Power |
| | Network |
| Performance | Support up to 8 sensor nodes |
| | Support feature extraction and classification |
| | simultaneously for HVAC, plumbing/water, |
| | electrical, pests and appliances |

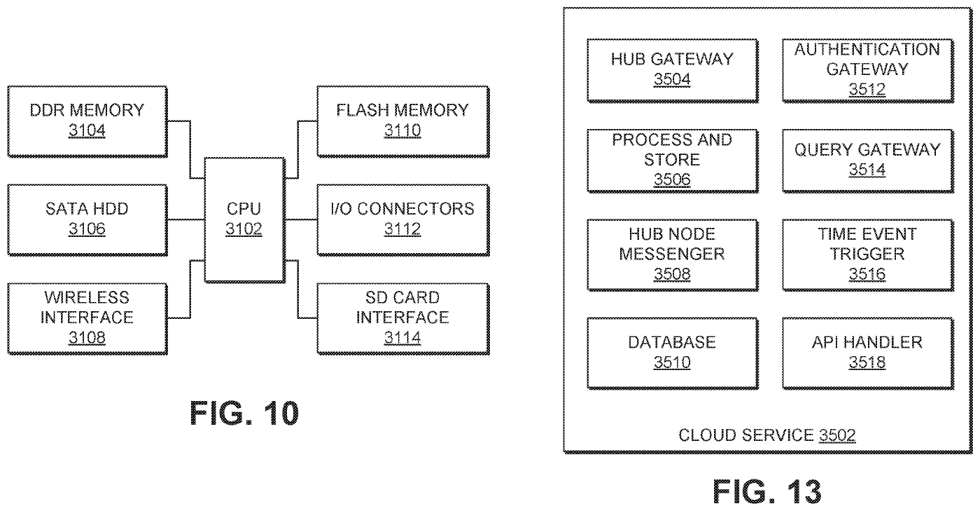

FIG. 10 is a block diagram of a hub device according to some embodiments. In the example of FIG. 10, the hub device is configured using the Intel NUC architecture, although alternative architectures may also be used. The hub device includes a CPU 3102 (e.g. a Core i7, 2.7-4.5 GHZ), DDR (double data rate) RAM memory 3104 (e.g. 8 MB), a SATA (Serial Advanced Technology Attachment) drive 3106 (e.g. a 256 GB solid state drive), a wireless interface 3108 (e.g. 802.11ac WiFi and/or Bluetooth 5), flash memory 3110, input/output connectors 3112 (e.g. 1000Base-T gigabit ethernet and/or USB 3.1), and an SD (Secure Digital) card interface 3114. The hub device may further be equipped with a trusted platform module, such as TPM2.0 key management.

### Processing of Sensor Data.

Various conditions and events may be detected in some embodiments using data collected by one or more sensors of a sensor node. As an example, detection of one or more of the following sounds may indicate that a toilet is flushing: composite sound of toilet flushing, composite ultrasound of toilet flushing, toilet handle press and release sound, water flush initialize sound, rapid water exit from bowl sound, toilet flushing vibrations, sound from fill valve hiss, ultrasound from fill valve hiss, water resonance (constant thumping), and/or sound of clogged toilet. Detection of one or more of the following may indicate that a toilet is filling: sound of bowl and tank refilling with water, sound of flapper valve closing, sound of water cutoff, vibrations of toilet filling, sound of toilet water running, relative humidity increase near toilet. A dripping sound in the toilet may indicate that the toilet is idle. Other sounds that may indicate events of interest with regard to a toilet may include the sound of a lid slamming downward onto the seat or upward onto the tank, or the sound of dripping on the floor. Detection of such events and conditions may be combined into composite data, such as the time the toilet spends in the flushing state, the detection of a broken chain based on two or more handle presses and releases in succession, time spent in the filling state, and average number of flushes per unit time.

Similarly, activity or conditions of a sink may be identified through detection of one or more of the following sounds: drip sound from faucet into empty bowl, drip sound from handle, drip sound into water in bowl, drip sound from sink fixtures or pipes, sink water running and striking bowl sounds, sink water running and bowl strike changed by usage, sound of sink handle being turned, and the sound of water moving through pipes toward the sink.

One example taxonomy of features in some embodiments is the following.

| Layer | Capability | Customer Benefit |
|---|---|---|
| 1 | Sensor Parameters | Direct Condition Monitoring |
| | with Thresholds | e.g. Temperature, Voltage, CO |
| 2 | Algorithms and | Enhanced Condition Monitoring |
| | Physics-based | e.g. Mold, Occupancy, HVAC |
| | Models | Efficiency, Wiring Faults |
| 3 | Al Classifiers | Operational Trends, Fault & |
| | | Anomaly Detection, and Predictive |
| | | Diagnostics |
| | | e.g. HVAC on/off, Toilet flush/fill, |
| | | Appliance Faults, AC compressor |
| | | failing |

Another example taxonomy of features in some embodiments is the following.

| Layer | Capability | Customer Benefit |
|---|---|---|
| 1 | Sensor Parameters | Direct Condition Monitoring and |
| | with Thresholds | Alerting e.g. Temperature, Voltage, CO |
| 2 | Algorithms and | Enhanced Condition Monitoring and |
| | Physics- | Alerting |
| | based Models | e.g. Mold, Occupancy, HVAC Efficiency, |
| | | Wiring Faults |
| 3 | Simple AI | Operational Insight and Component |
| | Classifiers | Trends |
| | | e.g. HVAC on/off, Toilet flush/fill, Shower |
| | | on/off |
| 4 | AI Classifiers | Fault Detection and Insight Identification |
| | with States | e.g. HVAC Equipment Faults, Appliance |
| | | Faults |
| 5 | Complex AI | Anomaly Detection and Predictive |
| | Classifiers | Diagnostics |
| | | e.g. AC compressor is failing, Change your |
| | | furnace run capacitor |

Sensor inputs that may be used to determine conditions and events in a dwelling may include one or more of the following: sound, temperature, humidity, CO, light, electricity, motion, and gases.

In some embodiments, multi-layered sensor processing is performed. The processing may include one or more of a universal acoustic detector, multi-modal sensor fusion, and anomaly detection.

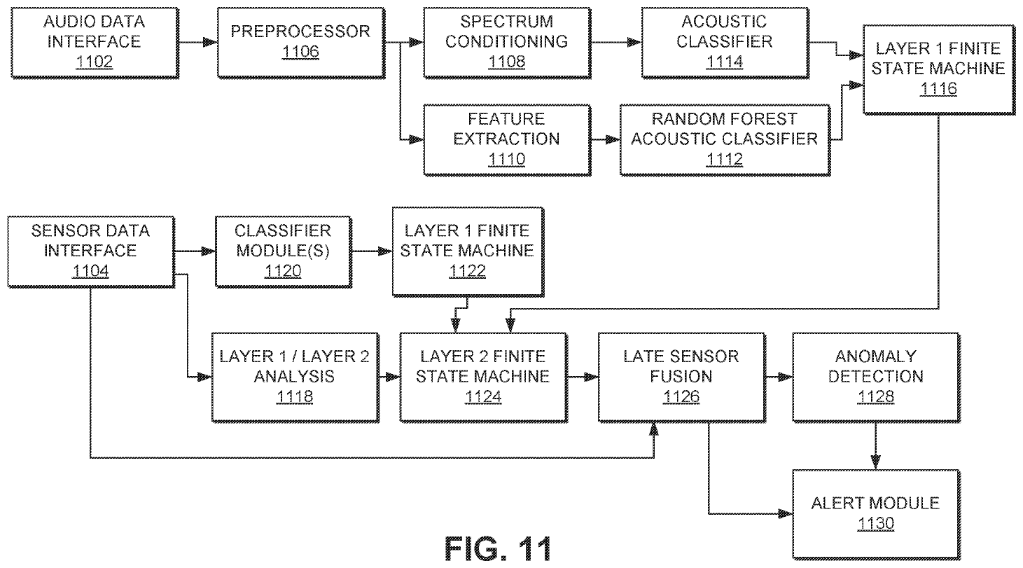

A functional diagram of an example classifier pipeline is illustrated in FIG. 11. In different embodiments, the operations illustrated in FIG. 11 may be distributed among different hardware components in different ways. For example, some operations may be performed by a sensor device, and some operations may be performed by a hub device. In some embodiments, some operations are performed by a cloud service. As illustrated in FIG. 11, audio data interface 1102 obtains audio data (e.g. data representing sounds present in an area of a dwelling). Audio data may include signals representing audible vibrations, such as sounds between around 20 Hz and 20 KHz. In some embodiments, the audio data is obtained in a series of one-second audio slices. A preprocessor 1106 processes the audio data, for example into 10-second sliding windows of spectrogram data. The sliding windows may be processed by a spectrogram conditioning module 1108 and by a feature extraction module 1110. The output of the feature extraction module 1110 may be provided to a random forest acoustic classifier 1112. The output of conditioning module 1108 may be provided to another acoustic classifier 1114, which may be a convolutional neural network (CNN) classifier operating on the spectrogram to determine a confidence level representing whether the audio signal represented by the spectrogram has a sound characteristic associated with an operating or failure state of a domestic fixture.

The output of one or more of the acoustic classifiers 1112 and 1114 may be provided to a layer-one finite state machine 1116 to stabilize the output of the classifiers. The layer-one finite state machine may have a first state representing an indication that the audio data does have the sound characteristic of interest and a second state representing an indication that the audio data does not have that sound characteristic. It may be the case that the raw output of the classifiers fluctuates rapidly as a result of confounding signals (e.g. extraneous noises in the dwelling). In some embodiments, the layer-one finite state machine 1116 stabilizes the classifier outputs by only changing state based on, for example, a time average of confidence levels or other function of a plurality of confidence levels. A different layer-one state machine may be provided for each of a plurality of sound characteristics of interest. The output of layer-one finite state machine 1116 may be referred to as a raw system state.

A sensor data interface 1104 obtains non-audio sensor data from one or more sensor nodes. The non-audio sensor data may include, for example, temperature data, humidity data, light data, accelerometer data, ultrasound data, VOC data, and/or electrical data. The sensor data may be provided to a layer-one/layer-two analysis module 1118. Layer one and layer two analysis is described in further detail below and includes such analysis as applying thresholds and/or physics-based models to one or more sensor parameters. The non-audio sensor data may also be provided to one or more classifier modules 1120. The output of the classifier modules 1120 and the layer-one/layer-two analysis module 1118 may be stabilized using a layer-one finite state machine 1122.

At least one layer-two finite state machine 1124 may also be provided. The layer-two finite state machine may have a plurality of states that represent corresponding states of a particular domestic fixture. For example, a layer-two finite state machine corresponding to a toilet may have states of idle, flushing, or tank refiling. A layer-two finite state machine corresponding to an HVAC system may have states of HVAC on and HVAC off. The layer-two finite state machine 1124 may receive inputs from some or all of layer one finite state machines 1116 and 1122 and layer-one/layer-two analysis module 1118. Based on the inputs, layer-two finite state machine 1124 determines whether to transition from a first state representing a first corresponding state of a domestic fixture to a second state representing a second corresponding state of the domestic fixture. The state represented by the state of layer-two finite state machine 1124 may be referred to as a refined state.

The output of the layer-two finite state machine 1124 may be provided to a sensor fusion module 1126, which may be referred to as a late sensor fusion module because it operates on data that has already been processed by one or more classifiers and/or finite state machines. The sensor fusion module 1126 operates to prevent false positives and/or false negatives by comparing the output of the layer-two finite state machine with other sensor data to generate a corrected state. For example, to prevent false positives, the sensor fusion module 1126 may determine that a domestic fixture is in a particular operating or failure state only if the sensor data and the output of the layer-two finite state machine are both consistent with the domestic fixture being in that state. To prevent false negatives, the sensor fusion module 1126 may determine that a domestic fixture is in a particular operating or failure state so long as either the sensor data or the output of the layer-two finite state machine is consistent with the domestic fixture being in that state. The operation of the sensor fusion module 1126 may thus vary in different use cases depending on factors such as the risk of overlooking a particular state versus the possible inconvenience of mistakenly detecting a particular state.

The corrected state provided by the sensor fusion module 1126 may be provided to an anomaly detection module 1128 for detection (e.g. through statistical analysis) of the risk of potential problems, and/or to an alert module 1130 to alert the user of existing or predicted problems.

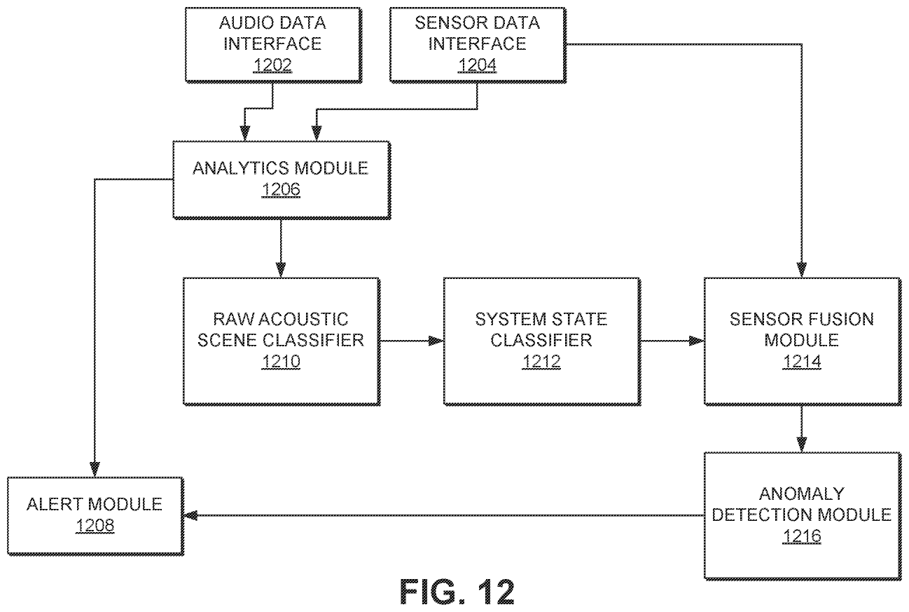

Another functional diagram is provided in FIG. 12, with a focus on acoustic processing. Audio data is obtained at an audio data interface 1202, and additional sensor data is obtained at sensor data interface 1204. An analytics module 1206 processes the data to provide alerts, warnings, and or insights as appropriate through alert module 1208 for cases where there is sufficient cause to issue alerts without requiring further AI processing. To generate insights and alerts that cannot be generated from simpler thresholding or similar techniques, audio data is provided to a raw acoustic scene classifier 1210. The resulting raw state is provided to a system state classifier 1212, which generates a refined state. The refined state is provided to a sensor fusion module 1214, which corrects and augments the classification using data from other (e.g. non-audio) sensors. The resulting corrected state may be used by an anomaly detection module 1216 to raise alerts and warnings and to provide insights, e.g. through the alert module 1208.

FIG. 13 illustrates features of a cloud service 3502 used in some embodiments. The service includes a hub gateway module 3504 for communication with hub nodes (or, in some embodiments, with sensor nodes). A process and store module 3506 processes data from the hub nodes for storage in a database 3510. A hub node messenger module 3508 manages messaging with hub nodes as described above with respect to FIG. 8. A UX authentication gateway module 3512 provides limited access as appropriate to authorized users, and a query gateway module 3514 allows authorized users to access the stored data, for example through a GraphQL interface. A time event trigger module 3516 coordinates timed events. An API handler module 3518 provides an interface with outside services and data providers, such as those providing messaging services, weather data, content management, property management, real estate, insurance, or other services or data.

Systems and methods according to some embodiments provide reports and alerts regarding safety, property damage, health risks, mechanical problems, home efficiency, and overall status for dwellings in which they are implemented. Some reports and alerts may be based on thresholds applied directly to sensor data. Voltage spikes, faulty wiring, and high carbon monoxide levels may be detected using such techniques. Some reports and alerts may be based on the statistics of sensor data. Dwelling occupancy and HVAC efficiency levels are conditions that may be determined using such techniques. Some reports and alerts may be based on machine learning, such as toilet flush and smart alarm detection. Some reports and alerts may be based on artificial intelligence, such as an indication of whether the HVAC is on, whether the toilet is filling, and whether the shower is on.

In some embodiments, a taxonomy of detection of conditions and events may be understood as follows. In “layer 1,” thresholds applied to sensor data together with physics-based logic may be used for condition monitoring and alerting. For example, high temperature alerts and electrical sags may be detected from sensor data using appropriate thresholds.

In “layer 2,” statistical analysis and physics-based modeling for may be implemented for condition modeling and alerting. For example, statistical modeling may be used to detect occupancy, to determine HVAC efficiency, and to detect wiring faults.

In “layer 3” machine learning and AI (e.g. neural networks) may be used to operate data-driven classifiers to detect operational states and identify faults. For example, such techniques may be used to detect whether the HVAC is on or off, whether the toilet is flushing or filling, or whether there are faults with appliances.

In “layer 4,” cross-sensor fusion and trend determination for anomaly detection and predictive diagnostics. For example, a detection may be made that the AC compressor is failing, or a recommendation may be made to change the furnace run capacitor.

Examples of statistics-based data processing results for an HVAC system include the following:
A rate of change of temperature for sensor node in room X more than one standard deviation away from whole house or from same sensor node a week ago may trigger an indication that the HVAC system for room X has either changed from last week or is different from whole home.
A distribution of temperature readings from room X that is different than distribution for room Y may trigger an indication that the HVAC system behaving differently in rooms X and Y.

Examples of statistics-based data processing results for detecting structural properties include the following:
Structural Stress Event: A determination that an entire set of sensor nodes in a home indicates lower frequency vibration energy exceeding earthquake levels may trigger an indication of potential structural damage.
Structural Tilt Event: In response to an entire set of sensor nodes in a home indicating a tilt angle change, an indication of potential structural damage or foundation/ground issue may be triggered.

In some embodiments, the system operates to determine correlations between readings of sensors of different modalities in the same or different sensor nodes. An atypical spike in one sensor at the same time as a spike in another, especially if repeated, may be used to provide an indication of a potential source or location of an issue. For example, a high CO reading that spikes at the same time as the noise level in utility room may trigger an alert of a potential gas leak from a gas dryer.

In some embodiments, alerts are provided in response to relevant sensor readings exceeding (or falling below) a threshold. Such alerts, however, often indicate that a problem has already occurred (e.g. the HVAC or furnace has already failed, or a water leak has already happened). Some embodiments operate to detect early warning signs of potential problems, such as running toilets and sump pump degradation.

In some embodiments, the house or appliance condition being detected is not a one-time event, and there are many occurrences that allow for classification of the event. Some embodiments use this to improve accuracy by analyzing many instances of the event before a determination is made to alert the building owner or resident of an issue. Examples of conditions that may be detected based on processing of sensor data include one or more of the following:

| Condition | Type | Comments |
|---|---|---|
| Stuck or | Chronic | Many chances to classify including |
| Continuous Fill | condition | times when humans are not present |
| | | and when background is quiet |
| Ghost Flushes | Chronic | Many chances to classify including |
| | condition | times when humans are not present |
| | | and when background is quiet |
| Water Dripping | Chronic | Many chances to classify including |
| | condition | times when humans are not present |
| | | and when background is quiet |
| Water on Floor | Acute | Indication (e.g. audible, wireless, or |
| | condition | other indication) from Contact Water |
| | | Sensor to the presence of water |

AI-based condition detection may be less accurate than threshold-based condition detection, at least for a single occurrence. However, accuracies are improved in some embodiments by combining results from repeated occurrences. For example, accuracies for HVAC and toilet performance tests have achieved average accuracies over 90%, and combining two or more independent classifications may reduce false positives to around 1% or lower.

Some embodiments further include a method of training an acoustic classifier using wholly or partly synthetic data. In additional embodiments, analogous training methods may be used for other sensor data too such as ultrasonic, vibration and so on. In an example training method, a plurality of (e.g. thousands of) synthetic floor plans are generated. Different construction materials are assigned to various different features of a synthetic room defined by the respective floor plans. Test audio of a monitored system (e.g., toilet overfilling) is collected. Synthetic sensor nodes are placed in different (e.g. random) locations within the synthetic scene. For each synthetic arrangement, a synthetic recording is made representing what a sensor node, placed at the relevant position within the synthetic scene, would detect in response to the sampled test audio being emitted at the position within the synthetic floor plan that corresponds to the location of the toilet. In some embodiments, sampled ambient noise (fans, TV, etc.) is also played back within the 3D audio environment as part of generating the synthetic recording. In this way, many (e.g. thousands or tens of thousands) of audio events may be generated and used to train an acoustic classifier (e.g. neural network) to classify sounds correctly in different acoustic conditions (e.g. different floor plans and materials) and with different ambient noises, without needing to generate a large number of recordings in actual dwellings. In some embodiments, real toilet sounds are sampled under acoustically isolated conditions (e.g. in a sound-insulated recording chamber) for use in generating the training data sets described here.

In some embodiments, the use of synthetic floor plans for training may be used in an initial training phase, e.g. before deployment into a dwelling. This initial training may be supplemented by or replaced with training based on actual data once sufficient data has been collected through the real-world use of deployed systems.

In an example use case implemented in some embodiments, a small fire breaks out in the back bedroom of a house. If a temperature sensor is in that room, it may report increasing temperatures as the fire spreads. From a temperature senor alone, it would not necessarily be possible to distinguish a small fire from, for example, natural heating of the room by sunlight. With temperature as the only sensed data, the fire would need to get rather large before it can be discriminated from normal occurrences. However, in example embodiments, a sensor node operates to detect not only temperature, but also a rise in VOC levels, a rise in CO levels, a shift in ambient light color, sounds associated with fire, an unusual outlet load detected on the electrical system (if the fire is an electrical fire), a drop in humidity, and possibly vibrations detectable by an accelerometer that are caused by furniture or structural damage. An event like a small fire gives out a wide range of sensor readings that can be examined collectively using sensor fusion to speed the accurate diagnosis of the event. In performing such sensor fusion, it is useful for sensor of different modalities to be provided in the same location. This is accomplished in example embodiments with the use of a sensor node having several different sensor modalities.

In some embodiments, error handling may be performed as follows. First, to obtain, high fidelity input data, a choice of sensors is optimized. The characterization and specification of the sensors may be selected for the desired application. The mechanical and electrical design of the sensors may be optimized. As-mounted and as-used sensor performance may be considered rather than relying solely on bench tests. Bias and other sensor errors are estimated and removed through post-processing to maximize output fidelity. Second, high quality individual event classifiers may be implemented. An optimized dataset may be constructed using a mix of carefully hand-labelled field captured data, data combinations and physics-based synthetic data. A mix of hand-tuned and machine-learned features may be used to give best class separation and performance. Both global and local classifiers may be used, with global classifiers serving to bootstrap and provide ensemble backup to local classifiers. Third, performance and user experience may be improved using context, redundancy, and machine learning. State aware sensor fusion may be used by implementing domain-specific state machine twins to auto-correct and flag AIE classifier errors. Local history may be considered, with multiple instances of potential threat detection compared to make final decision (for repeated instance threats). Some embodiments make use of an error-aware notification wording to the user. For each threat and error confidence estimates, a notification to the user may be worded and framed to reduce the impact of an error.

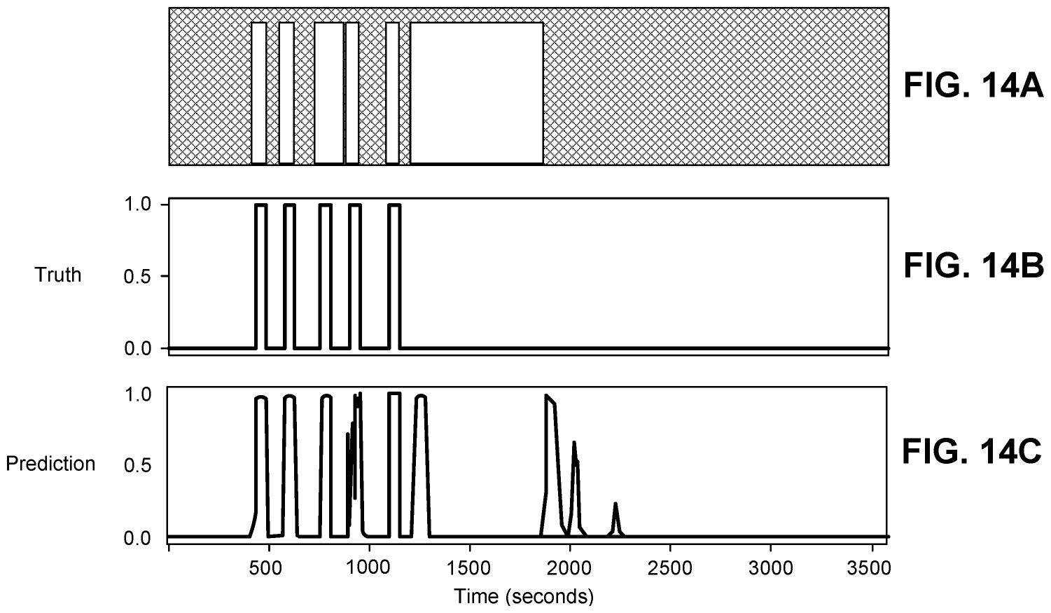

FIGS. 14A-14C schematically illustrate performance of a classifier used in some embodiments. FIG. 14A illustrates a spectrogram generated using audio data collected from a sensor node. The horizontal axis represents time and the vertical axis represents frequency components of the collected audio data. FIG. 14B illustrates times at which an event or condition (e.g. toilet flush) is actually occurring, with the value being 1 when it is occurring and 0 when it is not. FIG. 14C illustrates results output by an artificial intelligence classifier, such as a convolutional neural network (CNN) that has been trained to recognize the relevant event or condition. The input to the trained CNN may be a sliding window excerpted from the spectrogram. In the example shown in FIG. 14C, the classifier successfully detects each of the five actual events. The classifier further identifies some “false positives” with various levels of certainty. Such false positives may be caused by ambient noise (e.g. a shower sound that is mistakenly classified as a toilet flush). In a training stage, classification errors may be addressed by including in the training data audio that includes potentially confounding noises. In an operational stage, classification errors may be addressed using information from other sensors. For example, if the light sensor of a sensor node detects that the bathroom is in darkness, or if there are other indications that no person is around, a higher level of certainty may be required before a determination is made that a flush has occurred. Similarly, if a shower noise frequently leads to false positives in flush detection, a humidity detector may be used to detect that a shower is likely underway, and the level of certainty for detecting a flush may be raised.

With regard to HVAC systems, example embodiments may provide information on one or more of:
Temperature readings and alerts
HVAC Efficiency measurement, tracking and alerts
HVAC Runtime measurement, tracking
Thermal Retention measurement, tracking and alerts
Air Filter Cleanliness

With regard to water systems, example embodiments may provide information on one or more of:
Contact water sensor alerts
Bathroom fixture operation (e.g., toilet, sink, shower, tub)
Running toilet, Ghost flushing, Water dripping, etc. alerts
Sump pump operation

With regard to electrical systems, example embodiments may provide information on one or more of:
Outlet fault detection alerts
Surge, Swell, Sag measurement, tracking and alerts
Line voltage measurement, tracking and alerts

Example embodiments use collection and classification of acoustic data to detect and/or confirm detection of conditions and events in a dwelling. Many home conditions make sounds. Examples include a shower running, HVAC fan running, gushing water. Example embodiments provide multi-sensor fusion that may be implemented on a hub device, in which sound is paired with other sensed data such as humidity, gas, electricity, vibration and other types of sensor data to detect conditions and events in the dwelling. Deep learning models may be trained to provide a of map between multimodal sensors and appliance states of interest. Such embodiments may operate to identify patterns that would not be readily apparent to a human observer.

In some embodiments the following events and conditions are detected. In a taxonomy of evens and conditions, these may be categorized as Layer 1.

| Residence | | |
|---|---|---|
| System | Event or Condition | Impact |
| Electrical | Voltage Sag event | Potential damage to |
| | | appliances and HVAC |
| | Voltage Surge event | Potential damage to |
| | | appliances and HVAC |
| | Outlet Fault | Fire hazard |
| Environmental | Light On | Vacant apartment activity |
| | Moderate CO levels | Appliance fault and/or |
| | | Health hazard |
| | Poor Indoor Air | Health hazard |
| | Quality | |
| | Natural Gas detected | Health, Fire and Explosion hazard |
| | Freeze risk | Water pipe cracking risk |

In some embodiments the following events and conditions are detected. In a taxonomy of evens and conditions, these may be categorized as Layer 2.

| Residence | | |
|---|---|---|
| System | Event or Condition | Impact |
| Electrical | # Abnormal electrical events this | Signals potential stress to appliances |
| | week | |
| Noise | Noise indicating loud party | Tenant and noise ordinance |
| | detected | compliance |
| Occupancy | Human presence detected | Possible squatters in vacant unit |
| Energy | Light on in room x with no one | Possible energy waste |
| | present | |
| Environmental | Negative Air Pressure detected | Energy inefficiency and health |
| | | concern |
| HVAC | Average runtime for 1 degree of | Trend indicates HVAC health |
| Effectiveness | heating/cooling over past 30 days | |
| Temperature | Average time for 1 degree | Trend indicates insulation |
| Retention | change when HVAC off over past | effectiveness |
| | 30 days | |
| Vibration | Earthquake level shock detected | Possible structural damage |

In some embodiments the following events and conditions are detected. In a taxonomy of evens and conditions, these may be categorized as Layer 2.

| Residence | | |
|---|---|---|
| System | Event or Condition | Impact |
| Water/Plumbing | Toilet flush/fill cycle | Abnormal cycles signal running toilet |
| | | and ghost flushes |
| | Water dripping detection | Slow water leak detection |
| | Water leak alarm | Water presence detection |
| | Gushing water detection | Fast water leak detection |
| | Shower detection | Water usage metric and context |
| | Sink detection | Water usage metric and context |
| HVAC | Operation State | Feeds efficiency calculations |
| | detection | |
| Appliances | Washer operation | Occupancy detection and context |
| | Dryer operation | Occupancy detection and context |

### Example AI Flow.

As described above, some embodiments, the acoustic AI data processing may operate as follows:
1. Form a spectrogram of the last N seconds of acoustic data. N can be any number but a typical value is 10.
2. Feed that spectrogram as input to the neural net (NN) classifier, possibly augmented with some specialized acoustic features.
3. Threshold the neural net classifier based on an auto-calibration algorithm done in situ based in part on some state information from other sensors. An example is using temperature information to help determine if the HVAC is truly running—the same task the main NN classifier is charged with determining based on the acoustic sensor.
4. Run the NN classifier's thresholded output through a Finite State Machine (FSM) to increase stability of the classifier decisions.
5. Run the output of the first FSM through a second FSM that is aligned to the states of the appliance. This state machine brings in contextual knowledge of the appliance as well as possibly other sensor information to optimize performance. An example of this FSM would be one with an HVAC On state and an HVAC Off state.
6. Run the output of this second FSM through a Late Sensor Fusion stage which integrates information from other sensors to make a final determination. One use of this final stage in some embodiments is to remove False Positives. Another is to remove False Negatives. A third use in some embodiments is to estimate in situ classifier performance.

### Auto-Calibration.

In some embodiments, the neural net classifier is calibrated in-situ using a passive auto-calibration technique. One example technique leverages an auxiliary function that independently indicates whether the appliance or other domestic fixture of interest is operating or not. This secondary indicator may be noisy and include errors, but it can contribute to the improvement of the neural net classifier as long as it is more right than wrong.

An example of auto-calibration given below is the procedure AC-1.

AC-1: AUTO-CALIBRATION WITH FSM PROCEDURE
Procedure AC-1.

| | Input: cₖ (input classifier confidence for timestep k), tₖ (timestamp associated with cₖ) | | | | |
|---|---|---|---|---|---|
| | Config: MAX_LIST_LENGTH (max number of samples to do moving average on), | | | | |
| | W_{MA} (moving average window) | | | | |
| | Output: xxx | | | | |
| 1 | Initialize | | | | |
| 2 | For each new classification confidence input cₖ and associated tₖ: | | | | |
| 3 | | | list_{c}·append (cₖ) and listₜ·append (tₖ) and prune lists to MAX_LIST_LENGTH | | |
| 4 | | | list_{c}^{MA} = [moving_average(list_{c}[j], W_{MA})] # each list element is moving average of its window | | |
| 5 | | | cluster = calibrate(tₖ, cₖ^{MA} , cluster) where cₖ^{MA} is the entry in list_{c}^{MA} time-aligned with tₖ | | |
| 6 | | | | list_{pred} = [cluster · predict([c]) for c in list_{c}^{MA}] | |
| 7 | | | | If (state = = On) and (((sum(list_{pred})/len(list_{pred})) < error_thresh) then | |
| 8 | | | | | state = Off |
| 9 | | | | Else if (state = = Off) and (1 − ((sum(list_{pred})/len (list_{pred})) < error_thresh) then | |
| 10 | | | | | state = On |
| 11 | | | | thresh = mean(cluster · cluster_centers) | |
| 12 | | | | If state = = Off then | |
| 13 | | | | | $state \cdot confidence = mean ( [ \frac{( 2 * thresh ) - c}{2 * thresh} if c < thresh else 1 - ( \frac{2 * ( 1 - thresh ) - ( 1 - c )}{2 * ( 1 - thresh )} ) for c in {list}_{c} ] )$ |
| 14 | | | | else | |
| 15 | | | | | $state \cdot confidence = mean ( [ 1 - \frac{( 2 * thresh ) - c}{2 * thresh} if c < thresh else ( \frac{2 * ( 1 - thresh ) - ( 1 - c )}{2 * ( 1 - thresh )} ) for c in {list}_{c} ] )$ |
| 16 | | end | | | |
| 17 | end | | | | |

The procedure AC-1 in turn references the procedures AC-2 and AC-3. For ease of description, the example given is for an HVAC system, but the same principles can apply to other AI models as well.

Procedure AC-2.
AC-2: CALIBRATE METHOD FOR AUTOCAL PROCEDURE

| | Input: cₖ^{MA}(moving average of classifier confidence), |
|---|---|
| | tₖ (timestamp associated with cₖ^{MA} ), |
| | cluster (cluster object associated with this instance of AUTOCAL procedure), |
| | tempdf (temperature dataframe containing relevant indoor temperatures and associated timestamps for |
| | this home) |
| | Config: CAL_LENGTH (max number of samples to do calibration on) |
| | Output: Updated cluster if better one is identified |
| 1 | Initialize list_{cal} = [ ], list_{Old}^{On} = [ ], list_{Old}^{Off} = [ ], waitTime = 0 |
| 2 | tempdf_{cal} = tempdf [tempdf·time > (tₖ − CAL_LENGTH)] #pick recent history of temperatures |
| 3 | list_{cal}·append(cₖ^{MA}) and prune list to CAL_LENGTH |
| 4 | If len(list_{cal}) == CAL_LENGTH then |
| 5 | If list_{Old}^{On} is empty and list_{Old}^{Off} is empty then |
| 6 | list_{pred} = [cluster·predict([c]) f or c in list_{cal]} |
| 7 | list_{Old}^{On} = list_{pred}[c == 1] |
| 8 | listo_{Old}^{Off} = list_{pred}[c == 0] |
| 9 | If waitTime >= CHECK_TIME then |
| 10 | If did_HVAC_run(tempdf_cal) == True then |
| 11 | If (result := better_cluster(cluster, list_{cal},list_{Old}^{On} ,list_{Old}^{Off}, P_VALUE)) != None then |
| 12 | cluster, list_{Old}^{On} ,list_{Old}^{Off} = result |
| 13 | waitTime = 0 |
| 14 | else |
| 15 | waitTime += 1 |
| 16 | return cluster |
| 17 | end |

Procedure AC-3.
AC-3: BETTER_CLUSTER( ) METHOD FOR AUTOCAL PROCEDURE

| | Input: cluster, list_{cal}, list_{Old}^{On} ,list_{Old}^{Off},P_VALUE |
|---|---|
| | Config: CAL_LENGTH (max number of samples to do calibration on), |
| | N_{autocal} |
| | Output: Updated cluster,list_{New}^{On} ,list_{New}^{Off}, if better ones are identified or None |
| 1 | Initialize |
| 2 | cluster_{new} = form_{clusters}(num_{clusters} = 2)· fit (list_{cal}) |
| 3 | list_{pred} = [cluster_{new}·predict([c]) f or c in list_{cal}] |
| 4 | list_{New}^{On} = list_{pred}[c == 1] |
| 5 | list_{New}^{Off} = list_{pred}[c == 0] |
| 6 | If list_{New}^{On} is empty or list_{New}^{Off} is empty,return None |
| 7 | ttest_{On} = ttest_{independent}(list_{Old}^{On} ,list_{New}^{On}) |
| 8 | ttest_{Off} = ttest_{independent}(list_{Old}^{Off} ,list_{New}^{Off}) |
| 9 | on_{lowered} = True if ((ttest_{On}·stat > 0) and (ttest_{On}·pval < P_{VALUE})) else False |
| 10 | off_{raised} = True if ((ttest_{off}·stat < 0)and (ttest_{Off}·pval < P_{VALUE})) else False |
| 11 | update_{cluster} = True if ((on_{lowered} and off_{raised}) or (list_{New}^{On} is empty or list_{New}^{Off} is empty))or |
| | (on_{lowered} and (mean(cluster_{new}·centers) < mean(cluster·centers))) or |
| | (off_{raised} and (mean(cluster_{new}·centers) > mean(cluster·centers))) else False |
| 12 | If update_{cluster} then |
| 13 | return cluster,list_{New}^{On} , listoff_{New}^{Off} |
| 14 | else |
| 15 | return None |
| 16 | end |

As noted above, the auto-calibration algorithm makes use of an auxiliary indicator. For the HVAC example, one example of an auxiliary indicator is provided by the procedure LSF-1.

Procedure LSF-1.
LSF-1: DID_HVAC_RUN( ) METHOD FOR AUTOCAL PROCEDURE
AND AI POST-PROCESSING

| | Input: tempdf (temperature dataframe to use in determining if HVAC |
|---|---|
| | ran) |
| | Config: MIN_DURATION (minimum event duration required) |
| | Output: True if HVAC Ran else False |
| 1 | Initialize |
| 2 | start = tempdf·time·min( );end = tempdf·time·max( );duration = end − |
| | start |
| 3 | If duration < MIN_DURATION then return REJECT |
| 4 | cᵤₚ,c_{down} = evaluateCycle( tempdf) |
| 5 | if (len(cᵤₚ) > 0)and (len(c_{down}) > 0)then return True else return False |
| 6 | end |

The Procedure LSF-1 in turn references LSF-2 and LSF-3.

Procedure LSF-2.
LSF-2: EVALUATECYCLE( ) METHOD
FOR DID_HVAC_RUN( )

| | Input: tempdf (temperature dataframe to use in determining if HVAC |
|---|---|
| | ran) |
| | Config: MIN_DURATION (minimum event duration required), |
| | MIN_ABS_CHANGE (minimum temperature change required for |
| | each event) |
| | Output: cᵤₚ,c_{down} |
| 1 | Initialize cᵤₚ = [ ], c_{down} = [ ] |
| 2 | we = whenEvent(tempdf) |
| 3 | for each event in we,remove if duration < MIN_DURATION |
| 4 | for (start,end,slope)in we: |
| 5 | if slope > 0 then cᵤₚ·append((start,end,slope))else c_{down}·append |
| | ((start,end,slope)) |
| 6 | Sort all events in cᵤₚ and c_{down} by start time |
| 7 | Remove all events in cᵤₚ and c_{down} where absolute temperature |
| | change < MIN_ABS_CHANGE |
| 8 | return cᵤₚ,c_{down} |
| 9 | end |

Procedure LSF-3.
LSF-3: WHENEVENT( ) METHOD FOR EVALUATECYCLE

| | Input: tempdf |
|---|---|
| | Config: CAL_LENGTH (max number of samples to do calibration |
| | on), MIN_SLOPE (minimum allowed slope) |
| | Output: we |
| 1 | Initialize we = [ ], start = 0 |
| 2 | tck = 2nd degree bspline fit of tempdf |
| 3 | yhatdf = bspline(tck)·derivative·interpolate |
| 4 | for y in yhatdf : |
| 5 | if (start == 0) and (y ≥ MIN_SLOPE ) then start = y·time |
| 6 | else if (start! = 0) and (y < MIN_SLOPE ) then |
| 7 | end = y·time |
| 8 | slope = (y − yhatdf[start])/(end − start) |
| 9 | we·append((start,end,slope)) |
| 10 | if (start ! = 0) then |
| 11 | end = y·time |
| 12 | slope = (y − yhatdf[start])/(end − start) |
| 13 | we·append((start,end,slope)) |
| 14 | return we |
| 15 | end |

For ease of description, this example algorithm uses analysis of temperature time series data, though other types of data may be used to provide auxiliary indicators in other embodiments. Other embodiments may, alternatively or additionally, leverage different techniques including using an API to obtain thermostat data on when the HVAC system ran and/or a second AI model inferring operation from a different mix of sensors (e.g., electrical, vibration) and/or a different model.

Other clustering or classification techniques may be used for other auto-calibration techniques. In some embodiments, the current conditions in the home are processed to yield two distributions of AI model confidences for the operational state classifier of interest-one when the operational state is on and another when the operational state is off. Those condition changes are tracked in an effort to optimize the interpretation and therefore improve performance of the operational state classifier. In most cases, the effective result is to adjust the classification threshold on the output of the AI model inference result.

When auto-calibrating an HVAC classifier, one example set of parameters is as follows:
Calibration window duration (CAL_LENGTH in AC-2) of 90 minutes. This is due in part to the fact that typical HVAC run time (On time) for a home is 20 minutes.
A p-value of 0.05 (P_VALUE in AC-3) has been found to provide good results.
Checking interval (WAIT_TIME in AC-2) of 10 minutes generally works well.

Other domestic fixtures such as the toilet, sink or washing machine will generally have their own set of parameters which depend in part on usage patterns and the particular secondary detector employed for those appliances.

Different homes and different appliances or other domestic fixtures yield different confidences. Confounders like washers and dryers are often found in utility rooms and so confidences can change, and HVACs have different fan speeds, which can affect confidences. Such auto-calibration techniques allow for a passive in situ method of calibration so that adjustments for different conditions can be made automatically in each home.

### Classifier Finite State Machine.

An AI classifier's confidence in each inference run can vary quite a bit from one run to another. There are several potential reasons for this. For example, the AI inference may be done with windows or frames that overlap with the prior one. A particular event of interest might be split across different parts of different windows, and the whole event may span a greater period than any one window. These effects can lead to different levels of confidence. Confounding sounds, such as speech, television, and other sounds, may also be split across different windows, and may appear in some time windows but not others, similarly affecting the confidence determined for a particular window. If a single confidence threshold were used, this would result in unsteady inferences as the confidences rise above and then fall below the decision threshold. For example, a single “HVAC on” event in real life could result in many separate “HVAC on” events from the perspective of a classifier because the confidence levels are oscillating above and below the decision threshold.

It is also undesirable to miss legitimate events because of a decision threshold being too high for a particular set of field conditions. The confidence threshold that appears optimal for the training and validation data sets may not be optimal for field deployments. The use of a single decision threshold for deployments in many different dwellings is likely to lead to poor classifier performance.

In some embodiments, a classifier finite state machine is implemented using a moving average across a window of recent raw confidence results from the AI classifier. The particular length of the window may be selected for the desired implementation for this classifier, with shorter events having a shorter moving average window.

Example settings for an HVAC classifier that produces an output every second are given below.
Queue depth for Classifier FSM processing (MAX_LIST_LENGTH in AC-1) of 60 seconds is generally more than sufficient.
A moving average window size (WMA in AC-1) of 10 seconds generally works well.

Classifier FSM for other cases may be selected based on how frequently the classifier yields each prediction and the typical duration of the underlying event being classified. If the event is typically short in duration, the window size will generally be shorter. Parameters for the classifier FSM may be determined through field testing.

### Appliance Finite State Machine.

In general, optimal monitoring of home appliances and systems benefits from some knowledge about how that system works. Reporting on appliance operation benefits from some knowledge about the operational states that the appliance can be in and how they can transition from one to another. The particular operational states chosen may depend on the desired level of monitoring detail.

For example, a washing machine could be modeled as having two operational states: On or Running and Off or Idle. If it is only desired to know when the washing machine is used, these operational states may suffice. However, in some embodiments it may be desirable to obtain more refined detail on the washing machine, such as when it is filling with water (Fill), when it is agitating (Agitate), when it is draining out the water (Drain) and when it is spinning to wring out excess water from the load (Spin). In that case, the operational states of Fill, Agitate, Drain, Spin and Off may be selected.

The particular operational states chosen will vary depending on the desired monitoring and inference goals and the appliance of interest. Example embodiments use a finite state machine to track the appliance's current operational state. This allows monitoring of information such as the distribution of times the appliance remains in a particular operational state and which transitions typically occur out of one operational state to another. Variations in either of those things may be detected with statistical monitoring and may indicate an emerging maintenance issue with that appliance. Further, information regarding the current operational state may help with tuning and adjusting the associated AI models for this appliance. Note for example that the AC-1 procedure is implicitly structured around the operational state FSM for the appliance of interest—in this case the FSM.

One example of an implementation of an FSM is given by the procedure FSM-1. The operational state is kept as a variable, and the transition from one operational state to another is based on transition signals that come from the AI and processed sensor information that interface with the FSM.

Example finite state machines may be implemented in different ways, differing for example in the choice on hierarchy and the particular states. For a Washing Machine, for example, some embodiments may have could have the full FSM in one level with possible states of Off, Filling, Agitating/Washing, Spinning and Draining. Other embodiments may use a model with two levels, with the upper level having an Off and On state and a lower level triggered by the On state which includes the model for the Filling, Agitating/Washing, Spinning and Draining states.

The particular operational states in a particular embodiment may be chosen based on the desired inferences. If one is only interested in whether or not a particular domestic fixture was used, a simple FSM with just an Off and On state would suffice. For more detailed information about individual operational phases, it may be useful to have an FSM which includes at least one State corresponding to the operational phase of interest.

As one example, where the domestic fixture is a toilet, the appliance finite state machine AFSM-1 may be used to represent the operational or failure states of the toilet.

Procedure AFSM-1.
APPLIANCE AFSM-1: TOILET

| | Input: flushC (Flush Classifier, either ‘Flush’ or ‘Ambient’) , |
|---|---|
| | fillC (Fill Classifier, either ‘Fill’ or ‘Ambient’) |
| | Config: |
| | Output: toiletState |
| 1 | Initialize toiletState = Idle |
| 2 | If toiletState == Idle then |
| 3 | If flushC == ‘Flush’ then toiletState = Flushing |
| 4 | Else if fillC == ‘Fill’ then |
| 5 | Error “Missed Flush” |
| 6 | toiletState = Filling |
| 7 | Else if toiletState == Flushing then |
| 8 | If fillC == ‘Fill’ then toiletState = Filling |
| 9 | Else if flushC == ‘Ambient’ then |
| 10 | Error “Missed Fill” |
| 11 | toiletState = Idle |
| 12 | Else #toiletState == Filling |
| 13 | If fillC == ‘Ambient’ then toiletState = Idle |
| 14 | return toiletState |
| 15 | end |

As another example, where the domestic fixture is an HVAC system, the appliance finite state machine AFSM-2 may be used to represent the operational or failure states of the HVAC system.

Procedure AFSM-2.
APPLIANCE AFSM-2: HVAC

| | Input: hvacC (HVAC Classifier, either ‘On’ or ‘Off’) |
|---|---|
| | Config: |
| | Output: hvacState |
| 1 | Initialize hvacState = Idle |
| 2 | If hvacState == Idle then |
| 3 | If hvacC == ‘On’ then hvacState = On |
| 4 | Else #hvacState == On |
| 5 | If hvacC == ‘Off’ then hvacState = Idle |
| 6 | return hvacState |
| 7 | end |

As further example, a water leak appliance FSM may have a similar structure and flow to AFSM-2 but, instead of tracking the HVAC State of either On or Idle, the tracking is of the water leak state of either Leaking or Dry. Similarly, a smoke alarm virtual Appliance FSM has a similar structure and flow to AFSM-2 but, instead of tracking the HVAC State of either On or Idle, the tracking is of the smoke alarm state of either Smoke or Ambient. There may also be a parallel set of states to deal with low battery conditions (e.g., battery state of either Low or Normal).

### Sensor Fusion.

One example of sensor fusion with HVAC is illustrated in the procedure examples above, where the behavior of room temperatures when the HVAC system is actively cooling or heating the room is used in combination with a classifier to make a final determination regarding activity of the HVAC system.

Some embodiments use sensor fusion after the AI model has produced an inference result. This may be referred to as late sensor fusion (LSF). One alternative that can become attractive with extremely large datasets is to feed all the sensor data as inputs to a neural network for classification together. Such sensor fusion may be referred to as early sensor fusion (ESF). ESF can be a powerful technique. However, unless a big enough training dataset exists, use of ESF risks overfitting, or lack of generalization, or both, which can lead to unsatisfactory results.

One benefit of late sensor fusion in some embodiments is that it allows for in situ adjustments such as auto-calibration. Auto-calibration with ESF is more difficult because the relevant parameters are internal to the neural network.

A further benefit of late sensor fusion in some embodiments is that results of the data processing pipeline can be more easily interpreted, allowing for easier adjustment, assessment, and generalization of the AI model performance. Early sensor fusion, again, hides the relevant parameters within the neural network.

Different techniques of late sensor fusion may be employed for different embodiments, depending on the characteristics and nature of the secondary information available for sensor fusion. One option is to use it to identify and weed out false positives. Another option is to use it to identify likely false negatives.

In some embodiments, a late sensor fusion module receives input from a secondary classifier or algorithm that produces a decision which is expected to be similar to the one of the core AI model. In the example of HVAC the main AI model may determine whether or not the HVAC is On, using audio data, for example. A secondary classifier also determines whether or not the HVAC is On, but it using a completely different sensor set and model (such as temperature).

In some embodiments, LSF is used to assist with in situ tuning of the main AI model, as shown in the use of the LSF-1 method above in the AC-1 procedure. In some embodiments, LSF is used to assist with false positive removal. For example, depending on the performance goals for the overall inferencing and the relative field performance of the AI model and the LSF model, one could decide to require that HVAC On decisions be declared by both the AI model and the LSF in order to be accepted and used by the rest of the system. If only the AI model indicates HVAC On or only the LSF model indicates HVAC On, HVAC is declared Off.

In some embodiments, LSF is used to reduce false negatives. For example, it may be declared that HVAC is On if either the AI Model or LSF declare HVAC On. Some embodiments implement a more indirect method of improvement based on this same model by making local adjustments in training to the decision thresholds using this LSF step to pseudo-label samples and use them for additional candidate trainings of the AI model.

In some embodiments, the individual raw outputs of the classifiers and secondary indicator(s) function as inputs to a decision function or model. This puts the sensor fusion step right before the decision-making step of whether, for example, the current sample reflects the “On” or “Off” operational state. In some cases, this technique, which may be referred to as “middle sensor fusion” could allow for improved performance while maintaining explainability.

For the specific case of HVAC, as used in the detailed algorithm descriptions above, following settings have been found to be useful:
The minimum duration of an event (MIN_DURATION in LSF-1 and LSF-2) works well at 120 seconds.
The minimum absolute change in temperature (MIN_ABS_CHANGE in LSF-2) works well at 0.1 degrees Celsius.
The minimum slope of temperature change (MIN_SLOPE in LSF-3) works well at 0.00021 degrees C. per second.

Various types of auxiliary data can be used for sensor fusion and/or auto-calibration. For example, ambient light levels can be used as an auxiliary indicator of bathroom use since users often switch the lights on as they enter a bathroom. In addition, indoor air quality can be a secondary indicator of use due to VOC's produced by humans generally (e.g., breathing), human urine and human excrement. A third potential auxiliary indicator is vibration from an accelerometer due to water flushes. With regard to toilet operation, it has been found useful to model toilet flushing into two segments—the initial one labeled “Flush” (where water and waste exit the bowl) and a later one labeled “Fill” (where the tank and bowl fills up with new water). It has been found useful to perform LSF separately and differently on each of those two operational states.

In some embodiments, features of an FSM and LSF may by combined. For example, the classifier may declaring that a particular event happened, such as a Water Leak Alarm. But, in the course of doing the LSF portion, that declaration is rejected as a False Positive. In that case, the appliance FSM and any other system declarations may be adjusted accordingly to prepare for the next detection. In this example, the FSM would return to Off or Idle state instead of remaining in the Water Leak Alarm (On) state.

### Example System Hardware.

FIG. 52 schematically illustrates network topology used in some embodiments. One or more sensor nodes 3602a-c may be disposed in a residence, e.g. in different rooms. Each node may be plugged in to an electrical outlet. The sensor nodes are in wireless communication with a hub device 3604, e.g. using a WiFi connection or other local area network. The hub device 3604 may further have a connection to a wide-area network 3606 such as the internet through which a networked service 3608 running on one or more servers, such as a cloud service, may be accessed. Users may have personal devices such as a computer 3610 or mobile computing device 3612 that can also access the networked service 3608 over the network 3606. In some embodiments, the user interfaces described herein are displayed when the user accesses the networked service on their personal device. In some embodiments, the user's personal devices may be capable of communicating directly with the hub device 3604 and/or with the sensor nodes 3602a-c to view the user interfaces or to exchange other information. In some embodiments, the sensor nodes 3602a-c may be capable of communicating over the network 3606 without the intermediation of the hub device (e.g. through a router).

The hub device includes a memory, which may include a non-transitory memory, a processor, and one or more network interfaces for connection (e.g. a wireless connection) with the sensor nodes and with the internet (possibly through a router). The memory may store collected data (e.g. temperature and audio data) received from one or more sensor nodes. The memory may further store instructions that are executable by the processor for causing the processor to perform any of the methods described herein.

### Content Management System for Interface and Alert Parameters.

Some embodiments make use of a content management system to define not only the messages for the user interface but also the parameters for the associated alerts and charts used to show the fundamental parameters. This allows for the user experience and system designer to review, set and adjust in real-time both the operational and display elements associated with a given alert or chart.

In some embodiments, to define an alert through a content management system, a user provides some or all of the following information: a title for the alert (e.g. “High Temperature,” a security level (e.g. “Critical”), an alert type (e.g. “Temperature Alert”), a resolved alert type, and trigger information. The trigger information may include a first trigger (identifying the conditions that activate the alert state), an active state trigger (identifying conditions that lead to an updated alert), and a resolved state trigger (identifying conditions that indicate the resolution of the alert. For example, a first trigger may take the following form:

Above{{{threshold_range_min}}}*in {{{dnode_name}}}

An example of a corresponding active state trigger may have the following form:

Above{{{threshold_range_min}}}*in {{{dnode_name}}} for {{{duration}}}

An example of a corresponding resolved state trigger may have the following form:

Below{{{threshold_range_min}}}*in {{{dnode_name}}} for {{{duration}}}

The interface may similarly allow for the user to enter values for the thresholds used in the alert, such as temperature and duration thresholds. The interface may further allow a user to provide information regarding the duration and repetition of the alert.

Different parameters, templates and parameter names can be defined, and this is just one example. The parameters set in the CMS then drive the appropriate back-end and front-end cloud processing systems like our alert engine. An alternative would be to set those parameters either directly in the software or perhaps in fields of another database. By bundling them all in the CMS, the designer and systems engineers can see and adjust them simultaneously.

### Example Installation.

In some embodiments, a sensor node is provided for approximately each 300 square feet of a home. This may result in around six sensor nodes in a house. The sensor nodes may be configured to be plugged into a standard household power outlet (e.g. a North American power outlet in some embodiments, though other configurations may be used to accommodate different standards in some embodiments). The sensor nodes may be distributed to provide coverage at locations such as near a thermostat, near utilities (e.g. a furnace), in bathrooms and kitchens, and in a main living area. In some embodiments, one hub node is provided per house. The hub node connects to a household power source and to a WiFi router or other network connection. In some embodiments, water sensor nodes may also be provided. The water sensor nodes may be water leak contact sensors. The water sensors may be battery powered to allow for safe and flexible positioning at locations where water is at risk of accumulation. In one example, five such water sensors are provided in a house. With the use of such a system, an authorized party can access real-time reports and alerts through a management dashboard accessible through a web interface.

### Privacy and Data Management.

Example embodiments further operate to protect the privacy of occupants of a dwelling. In some embodiments, for performance verification and enhancement purposes, a subset of snippets, which are several seconds long, may be sent to a cloud service for processing if appropriate user permission has been received. However, in some embodiments, the use of synthetic data for AI training and a local hub device for AI processing allows for AI training and enhancement without the need to process field data in the cloud, reducing the amount of data that is shared outside the dwelling.

In some embodiments, Customer Identifiable Information (CII) such as account date is stored in a secure CII repository as needed for billing and privacy management. Such information may include a user's name, address and billing information. The data for a user may be associated with a hub device identifier, and users may be provided access only to their own operational data. The CII repository may be isolated from operational data.

Non-CII information, such as operational data, may be stored separately from CII information. Operational data may include data used for a service offering. The operational data may include, for each property, sensor data and a history of conditions and events detected using AI processing. In some embodiments, the AI processing is performed locally, e.g. in a hub device (such as the dHub). In such embodiments, user privacy is improved because it is not necessary to send all the data used by the AI processing to the cloud service. In some embodiments, data representing only short (e.g. 1 second) audio samples are provided to a cloud service. Such samples may be sent in a form that is not feasible to convert back into intelligible sound, for example as a spectrogram or an embedding. In some embodiments, such audio samples are provided to the cloud service only after a determination is made that no speech is detected in the sample. In some embodiments, longer audio clips are provided to a cloud service only after specific user authorization is received. In some embodiments, non-CII information may be indexed by an identifier of the associated hub device (e.g. a dHub ID). In some embodiments, that identifier is not correlated in the operational data with the user's name and address.

In some embodiments, anonymized data is collected and used in producing and improving AI models. Such data may be referred to as “flywheel data.” In some embodiments, this flywheel data includes extracts of operational data at least 30 days old where identification information (e.g. dHub ID) has been stripped out so that no link to a specific customer is feasible. Data representing short, select audio clips may be transferred but, absent user consent, longer audio clips are not. In some embodiments, data may be indexed with a randomly generated number uncorrelated with the dHub ID, and no record of that mapping is kept.

In some embodiments, systems as described herein exchange data with external systems to obtain, for example, information regarding weather, information on appliances and repair, ordering information for parts replacement or upgrade, and the like. In some embodiments, data may be shared with entities providing home security, repair, upgrade, or insurance services.

### Adaptive Upgrade Capabilities.

In some embodiments, some of the features described herein may be implemented in a sensor node and/or hub node when a system is installed in a dwelling, while other features may be made available at a later time through software upgrades and/or provisioning provided over a network after installation without requiring changes to hardware.

In some embodiments, maintenance events and conditions that are detected and reported to a user may include one or more of the following:
CO issue
outlet issue
water leak alarm in one home, avoiding further damage
failed humidifier
failed dehumidifier in crawlspace
occupancy or human presence

Different types of user questions and interactions that may be accommodated in some embodiments may be described using the following taxonomy. Layer 1 may include information on a current status. Layer 2 may provide information on trends. Layer 3 may provide further analysis and details.

### Additional Features of Some Embodiments

Example embodiments provide detection of events and conditions that may be useful in directing efforts for home maintenance. Detection of events and conditions using systems and methods disclosed herein allows for accurate, comprehensive, and actionable insights for whole home remote predictive maintenance. As examples, the following information may be provided to a user regarding an HVAC system.
HVAC Efficiency measurement and tracking
HVAC Runtime measurement and tracking
Thermal Retention measurement and tracking
Air Filter cleanliness

As additional examples, the following information may be provided to a user regarding a plumbing system.
Bathroom fixture operation (e.g., toilet, sink, shower, tub)
Running toilet detection
Ghost flushing detection
Water drip detection
Sump pump operation

A method according to some embodiments includes, at a sensor node comprising a microphone and at least one non-acoustic additional sensor, operating the microphone to collect an audio sample, and operating the non-acoustic additional sensor to collect at least one additional sensor reading; and detecting at least one event or condition based at least in part on the audio sample and the at least one additional sensor reading.

In some embodiments, the detecting includes generating a spectrogram of at least a portion of the audio sample; and providing the spectrogram as an input to a neural network classifier, the classifier being configured to provide a classifier output representing detection of a sound associated with the event or condition.

In some embodiments, the neural network classifier is a convolutional neural network.

Some embodiments further include communicating the audio sample and the at least one additional sensor reading to a hub device, wherein the detecting is performed by the hub device.

Some embodiments further include communicating the detection of the event or condition to a user.

Some embodiments further include detecting a plurality of occurrences of the event or condition and communicating statistical information regarding the plurality of occurrences to a user.

In some embodiments, the non-acoustic sensors comprise one or more of the following: a carbon monoxide (CO) sensor, an air pressure sensor, an accelerometer, a temperature sensor, a humidity sensor, a volatile organic compound (VOC) sensor, an ambient light sensor, or a voltage sensor.

In some embodiments, wherein at least one of the non-acoustic sensors is a carbon monoxide (CO) sensor, the event or condition is a CO leak at an appliance, and the detection of the event or condition is based at least on detection of a sound associated with operation of the appliance and an elevated CO level detected by the CO sensor.

In some embodiments, the method of any of claims 1-7, wherein at least one of the non-acoustic sensors is a carbon monoxide (CO) sensor, the event or condition is a fire, and the detection of the event or condition is based at least on detection of a sound associated with fire and an elevated CO level detected by the CO sensor.

In some embodiments, at least one of the non-acoustic sensors is an air pressure sensor, the event or condition is operation of an HVAC system, and the detection of the event or condition is based at least on detection of a sound associated with operation of the HVAC system and a pressure change detected by the pressure sensor.

In some embodiments, at least one of the non-acoustic sensors is an air pressure sensor, the event or condition is occupancy of a dwelling, and the detection of the event or condition is based at least on detection of a sound associated with occupancy of the dwelling and a pressure change detected by the pressure sensor indicating opening or closing of doors and/or windows.

In some embodiments, at least one of the non-acoustic sensors is an accelerometer, the event or condition is a seismic event, and the detection of the event or condition is based at least on detection of a sound associated with a seismic event and a shaking condition detected by the accelerometer.

In some embodiments, at least one of the non-acoustic sensors is an accelerometer, the event or condition is a structural shifting event, and the detection of the event or condition is based at least on detection of a sound associated with a structural shifting event and a change in tilt direction detected by the accelerometer.

In some embodiments, at least one of the non-acoustic sensors is an accelerometer, the event or condition is occupancy of a dwelling, and the detection of the event or condition is based at least on detection of a sound associated with occupancy of the dwelling and footsteps detected by the accelerometer.

In some embodiments, at least one of the non-acoustic sensors is a temperature sensor, the event or condition is operation of a bath or shower, and the detection of the event or condition is based at least on detection of a sound associated with the bath or shower and a temperature change detected by the temperature sensor.

In some embodiments, at least one of the non-acoustic sensors is a temperature sensor, the event or condition is operation of an HVAC system, and the detection of the event or condition is based at least on detection of a sound associated with operation of the HVAC system and a temperature change detected by the temperature sensor.

In some embodiments, at least one of the non-acoustic sensors is a temperature sensor, the event or condition is a fire, and the detection of the event or condition is based at least on detection of a sound associated with the fire and a temperature increase detected by the temperature sensor.

In some embodiments, at least one of the non-acoustic sensors is a humidity sensor, the event or condition is operation of a bath or shower, and the detection of the event or condition is based at least on detection of a sound associated with the bath or shower and a humidity increase detected by the humidity sensor.

In some embodiments, at least one of the non-acoustic sensors is a humidity sensor, the event or condition is a water leak, and the detection of the event or condition is based at least on detection of a sound associated with a water leak and a humidity increase detected by the humidity sensor.

In some embodiments, at least one of the non-acoustic sensors is a humidity sensor, the event or condition is operation of an HVAC system, and the detection of the event or condition is based at least on detection of a sound associated with operation of the HVAC system and a humidity decrease detected by the humidity sensor.

In some embodiments, at least one of the non-acoustic sensors is a humidity sensor, the event or condition is sump pump failure, and the detection of the event or condition is based at least on a humidity increase detected by the humidity sensor and detection of at least one of the following: a sound associated with faulty sump pump, or an absence of sounds associated with a sump pump.

In some embodiments, at least one of the non-acoustic sensors is a VOC sensor, the event or condition is a fire, and the detection of the event or condition is based at least on detection of a sound associated with the fire and an increase in VOC levels detected by the temperature sensor.

In some embodiments, at least one of the non-acoustic sensors is a VOC sensor, the event or condition is a gas leak at an appliance, and the detection of the event or condition is based at least on detection of a sound associated with operation of the appliance and an elevated VOC level detected by the VOC sensor.

In some embodiments, at least one of the non-acoustic sensors is a voltage sensor coupled to an electrical outlet, the event or condition is operation of an appliance, and the detection of the event or condition is based at least on detection of a sound associated with operation of the appliance and a voltage transient detected by the voltage sensor.

In some embodiments, at least one of the non-acoustic sensors is an ambient light sensor, the event or condition is occupancy of a dwelling, and the detection of the event or condition is based at least on detection of a sound associated with occupancy of a dwelling and operation of lights detected by the ambient light sensor.

In some embodiments, at least one of the non-acoustic sensors is an ambient light sensor, the event or condition is a ghost flush of a toilet, and the detection of the event or condition is based at least on detection of a sound associated with a toilet flush and a low level of light detected by the ambient light sensor.

A method according to some embodiments includes collecting audio data at a sensor node; for each of a plurality of occurrences of an event in a first time period, determining a duration of the event based at least in part on the audio data; determining first statistics characterizing the durations of the plurality of occurrences in the first time period; for each of a plurality of occurrences of the event in a second time period, determining a duration of the event based at least in part on the audio data; determining second statistics characterizing the durations of the plurality of occurrences in the second time period; and comparing the first statistics and second statistics.

In some embodiments, determining a duration includes: generating a spectrogram of at least a portion of the audio data; and providing the spectrogram as an input to a neural network classifier, the classifier being configured to provide a classifier output indicating detection of a sound associated with the event.

In some embodiments, the neural network classifier is a convolutional neural network.

Some embodiments further include communicating the audio data to a hub device, wherein the determination of the duration of the events is performed by the hub device.

In some embodiments, comparing the first statistics and second statistics comprises detecting a change in the first and second statistics, and wherein the method further includes communicating information indicating the change to a user.

In some embodiments, comparing the first statistics and second statistics comprises detecting a change in average duration between the first time period and second time period, and wherein the method further includes communicating information indicating the change to a user.

In some embodiments, the event is a toilet flush, the method further comprising providing an alert to a user in response to a detected increase in toilet flush duration.

In some embodiments, the event is sump pump operation, the method further comprising providing an alert to a user in response to a detected change in duration of sump pump operation.

A method according to some embodiments includes: collecting audio data at a sensor node; for each of a plurality of occurrences of an event in a first time period, determining a first number of occurrences of the event based at least in part on the audio data; for each of a plurality of occurrences of the event in a second time period, determining a second number of occurrences of the event based at least in part on the audio data; and comparing the first number of occurrences and the second number of occurrences.

In some embodiments, determining a number of occurrences includes: generating a spectrogram of at least a portion of the audio data; providing the spectrogram as an input to a neural network classifier, the classifier being configured to provide a classifier output indicating detection of a sound associated with the event.

In some embodiments, the neural network classifier is a convolutional neural network.

Some embodiments include communicating the audio data to a hub device, wherein the determination of the number of the occurrences is performed by the hub device.

In some embodiments, the method further includes communicating information indicating a change in the number of occurrences to a user.

In some embodiments, the event is operation of a domestic fixture such as an appliance.

In some embodiments, the event is operation of a plumbing fixture.

A method according to some embodiments includes: collecting audio data at a sensor node; for a plurality of occurrences of an event in a first time period, determining a first total duration of the occurrences based at least in part on the audio data; for a plurality of occurrences of the event in a second time period, determining a second total duration of the occurrences based at least in part on the audio data; comparing the first total duration and the second total duration.

In some embodiments, determining the total duration includes: generating a spectrogram of at least a portion of the audio data; and providing the spectrogram as an input to a neural network classifier, the classifier being configured to provide a classifier output indicating detection of a sound associated with the event.

In some embodiments, the neural network classifier is a convolutional neural network.

Some embodiments further include communicating the audio data to a hub device, wherein the determination of the total duration is performed by the hub device.

In some embodiments, the method further includes communicating information indicating a change in the total duration to a user.

In some embodiments, the event is operation of a domestic fixture such as an appliance.

In some embodiments, the event is operation of a plumbing fixture.

A system according to some embodiments includes at least one processor configured to perform any of the methods described herein.

A system according to some embodiments includes a plurality of modules configured to perform any of the methods described herein.

Any feature described herein as a module may be implemented with structures including, but not limited to, one or more processors and at least one storage medium (e.g. a non-transitory storage medium) storing instructions that are operative, when executed on the one or more processors, to perform any functions associated with the module. Such a module may further include any appropriate environmental sensors (e.g. a thermometer, hygrometer, microphone) or input or output devices (e.g. screens, keyboards, network interfaces) used to implement the functions associated with the module. In some embodiments, computing operations may be implemented by circuitry other than a processor, such as by a field-programmable gate array (FPGA) or other logic circuitry. The componentry used to implement a module may in some embodiments be distributed among different physical devices that communicate with one another to perform the associated functions.

A method according to some embodiments includes obtaining audio data representing captured sound in a dwelling; applying a first classifier on the audio data to make a first determination of whether the audio data includes a first predetermined sound associated with a domestic fixture; obtaining non-audio sensor data from a sensor in the dwelling; applying a second classifier on the non-audio sensor data, the second classifier being different from the first classifier, to make a second determination of whether the domestic fixture is in a first state associated with the first predetermined sound; and based at least on the first determination and the second determination, making a third determination of whether the domestic fixture is in the first state.

Some embodiments further include calibrating the first classifier based on the second determination.

In some embodiments, making the first determination further comprises determining whether to transition a first finite state machine between a state in which the audio data is determined not to include the first predetermined sound and a state in which the audio data is determined to include the first predetermined sound.

In some embodiments, making the third determination further comprises determining, based on the first determination from the first classifier and the second determination from the second classifier, whether to transition a second finite state machine into the first state, the second finite state machine having states representing states of the domestic fixture.

In some embodiments, the third determination includes a determination that the domestic fixture is in the first state only if: the first determination includes a determination that the audio data includes the first predetermined sound, and the second determination includes a determination that the domestic fixture is in the first state.

In some embodiments, the third determination includes a determination that the domestic fixture is in the first state if either one of the following conditions is met: the first determination includes a determination that the audio data includes the first predetermined sound, or the second determination includes a determination that the domestic fixture is in the first state.

In some embodiments, the first classifier is applied to a sliding window of audio data.

Some embodiments further include: based on the third determination, compiling statistical information regarding the domestic fixture; based on a change in the statistical information, identifying a potential defect in the domestic fixture; and issuing an alert of the identified potential defect.

In some embodiments, the statistical information includes at least one of: information regarding how often the domestic fixture is in the first state, information regarding a typical duration of time the domestic fixture is in the first state, or information regarding a total amount of time the domestic fixture has spent in the first state. Identifying a potential defect may be performed in response to at least one of the following: a change in the statistical information, a threshold exceeded by the statistical information, or an occurrence of the first state that is anomalous with respect to the statistical information.

In some embodiments, the domestic fixture is an HVAC system and the non-audio sensor data is temperature sensor data.

In some embodiments, the first classifier is a convolutional neural net classifier. One way to begin training the classifier is as follows: obtaining a plurality of audio samples of the first predetermined sound; generating a plurality of synthetic floor plans; selecting at least one microphone position and at least one fixture position within each of the synthetic floor plans; for each audio sample, generating a plurality of synthetic audio samples by processing each audio sample to estimate a sound as received at the microphone position when emitted from the respective fixture positions within the respective synthetic floor plans; and training the first classifier to detect the first predetermined sound using the plurality of synthetic audio samples. Such training may later be supplemented or replaced with training based on data collected through real-world deployments of sensor nodes.

A system in some embodiments includes at least one processor configured to perform: obtaining audio data representing captured sound; applying a first classifier on the audio data to make a first determination of whether the audio data includes a first predetermined sound associated with a domestic fixture; obtaining non-audio sensor data; applying a second classifier on the non-audio sensor data, the second classifier being different from the first classifier, to make a second determination of whether the domestic fixture is in a first state associated with the first predetermined sound; and based at least on the first determination and the second determination, making a third determination of whether the domestic fixture is in the first state.

In some embodiments, the processor is further configured to calibrate the first classifier based on the second determination.

In some embodiments, making the first determination further comprises determining whether to transition a first finite state machine between a state in which the audio data is determined not to include the first predetermined sound and a state in which the audio data is determined to include the first predetermined sound.

In some embodiments, making the third determination further comprises determining, based on the first determination from the first classifier and the second determination from the second classifier, whether to transition a second finite state machine into the first state, the second finite state machine having states representing states of the domestic fixture.

A system according to some embodiments further includes a sensor node including a microphone, at least one non-audio sensor, and a first network interface configured to transmit the audio data and the non-audio sensor data; and a hub node including at least one of the processors and a second network interface configured to receive the audio data and the non-audio sensor data, the processor of the hub node being configured to make at least the third determination.

Some embodiments further include a voltage sensor, wherein the non-audio sensor data includes voltage data obtained by the voltage sensor.

In some embodiments, the first classifier is a convolutional neural net classifier trained using a method comprising: obtaining a plurality of audio samples of the first predetermined sound; generating a plurality of synthetic floor plans; selecting at least one microphone position and at least one fixture position within each of the synthetic floor plans; for each audio sample, generating a plurality of synthetic audio samples by processing each audio sample to estimate a sound as received at the microphone position when emitted from the respective fixture positions within the respective synthetic floor plans; and training the first classifier to detect the first predetermined sound using the plurality of synthetic audio samples.

In some embodiments, the first classifier is a neural network classifier and the second classifier is not a neural network classifier.

In some embodiments, the first determination is made based on a time series of confidence levels generated by the first classifier, the confidence levels being based on a sliding window of audio data.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Other variations of the described embodiments are contemplated. The above-described embodiments are intended to be illustrative, rather than restrictive, of the present invention. The scope of the invention is thus not limited by the examples given above but rather is defined by the following claims.

1. A method comprising:
obtaining first audio data representing sound present in an area of a dwelling;
applying a first classifier on the first audio data to make a first determination of whether the audio data has a first sound characteristic associated with an operating or failure state of a domestic fixture;
obtaining sensor data from a sensor in the dwelling;
based on the sensor data, making a second determination, independent of the first audio data, of whether the domestic fixture is in the first state; and
based at least on the first determination and the second determination, making a third determination of whether the domestic fixture is in the first state.

2. The method of claim 1, further comprising calibrating the first classifier based on the second determination.

3. The method of claim 1, wherein making the first determination further comprises determining whether to transition a first finite state machine between a state in which the audio data is determined not to have the sound characteristic and a state in which the audio data is determined to have the sound characteristic.

4. The method of claim 1, wherein making the third determination further comprises determining, based on the first determination from the first classifier and the second determination based on the sensor data, whether to transition a second finite state machine into the first state, the second finite state machine having a plurality of states representing respective states of the domestic fixture.

5. The method of claim 1, wherein the third determination includes a determination that the domestic fixture is in the first state only if:
the first determination includes a determination that the audio data includes the first predetermined sound, and
the second determination includes a determination that the domestic fixture is in the first state.

6. The method of claim 1, wherein the third determination includes a determination that the domestic fixture is in the first state if either one of the following conditions is met:
the first determination includes a determination that the audio data includes the first predetermined sound, or
the second determination includes a determination that the domestic fixture is in the first state.

7. The method of claim 1, wherein the first classifier is applied to a sliding window of audio data.

8. The method of claim 1, further comprising:
based on the third determination, compiling statistical information regarding the domestic fixture;
based on a change in the statistical information, identifying a potential defect in the domestic fixture; and
issuing an alert of the identified potential defect.

9. The method of claim 8, wherein the statistical information includes at least one of: information regarding how often the domestic fixture is in the first state, information regarding a typical duration of time the domestic fixture is in the first state, or information regarding a total amount of time the domestic fixture has spent in the first state and
wherein identifying a potential defect is performed in response to at least one of the following: a change in the statistical information, a threshold exceeded by the statistical information, or an occurrence of the first state that is anomalous with respect to the statistical information.

10. The method of claim 1, wherein the domestic fixture is an HVAC system and the sensor data is temperature sensor data.

11. The method of claim 1, wherein the first classifier is a convolutional neural net classifier trained by a method comprising:
obtaining a plurality of audio samples of audio data having the first sound characteristic;
generating a plurality of synthetic floor plans;
selecting at least one microphone position and at least one fixture position within each of the synthetic floor plans;
for each audio sample, generating a plurality of synthetic audio samples by processing each audio sample to estimate a sound as received at the microphone position when emitted from the respective fixture positions within the respective synthetic floor plans; and
training the first classifier to detect the first sound characteristic using the plurality of synthetic audio samples.

12. A system comprising at least one processor configured to perform:
obtaining first audio data representing sound present in an area of a dwelling;
applying a classifier on the first audio data to make a first determination of whether the first audio data has a first sound characteristic associated with a domestic fixture, wherein making the first determination includes stabilizing an output of the classifier using a first finite state machine;
based at least in part on the first determination, making a second determination of whether to transition a second finite state machine from a first state to a second state, the second finite state machine having a plurality of states representing respective operating or failure states of the domestic fixture; and
based at least in part on a current state of the second finite state machine, making a third determination of a current operating or failure state of the domestic fixture.

13. The system of claim 12, wherein the processor is further configured to perform:
obtaining sensor data from a sensor in the dwelling;
wherein the third determination is further based at least in part on the sensor data.

14. The system of claim 13, wherein the sensor includes a voltage sensor.

15. The system of claim 13, wherein the sensor includes a temperature sensor.

16. The system of claim 12, wherein the processor is further configured to perform:
obtaining sensor data from a sensor in the dwelling;
based at least in part on the sensor data, making a fourth determination, independent of the first audio data, of the current operating or failure state of the domestic fixture; and
calibrating the classifier based at least in part on the fourth determination.

17. The system of claim 12, wherein stabilizing the output of the classifier comprises determining, based on a series of outputs from the classifier, whether to transition the first finite state machine between a state in which the first audio data is determined not to have the first sound characteristic and a state in which the audio data is determined to have the first sound characteristic.

18. The system of claim 12, further comprising:
a sensor node including a microphone, at least one non-audio sensor, and a first network interface configured to transmit the audio data and the non-audio sensor data; and
a hub node including at least one of the processors and a second network interface configured to receive the audio data and the non-audio sensor data, the processor of the hub node being configured to make at least the third determination.

19. The system of claim 18, wherein the sensor node includes a set of power plug prongs and a voltage sensor coupled to the prongs, and wherein the non-audio sensor data includes voltage data obtained by the voltage sensor.

20. The system of claim 12, wherein the classifier is a convolutional neural net classifier trained using a method comprising:
obtaining a plurality of audio samples having the first sound characteristic;
generating a plurality of synthetic floor plans;
selecting at least one microphone position and at least one fixture position within each of the synthetic floor plans;
for each audio sample, generating a plurality of synthetic audio samples by processing each audio sample to estimate a sound as received at the microphone position when emitted from the respective fixture positions within the respective synthetic floor plans; and
training the first classifier to detect the first predetermined sound using the plurality of synthetic audio samples.

21-29. (canceled)
